(19) United States
(12) Patent Application Publication
(10) Pub. No.: US 2024/0393301 A1
(43) Pub. Date: Nov. 28, 2024

(54) CALIBRATION OF ANALYTICAL INSTRUMENT

(71) Applicants: Thermo Fisher Scientific (Bremen) GmbH, Bremen (DE); Thermo Finnigan LLC, San Jose, CA (US)

(72) Inventors: Kyle Fort, Bremen (DE); Eloy Wouters, San Jose, CA (US); Alexander Makarov, Bremen (DE); Brian Adamson, San Jose, CA (US)

(73) Assignees: Thermo Fisher Scientific (Bremen) GmbH, Bremen (DE); Thermo Finnigan LLC, San Jose, CA (US)

(21) Appl. No.: 18/670,454

(22) Filed: May 21, 2024

Related U.S. Application Data
(60) Provisional application No. 63/468,170, filed on May 22, 2023.

(51) Int. Cl. G01N 30/86; G01N 30/02; G01N 30/72; H01J 49/42

(52) U.S. Cl. CPC G01N 30/8665; G01N 30/7233; G01N 30/8624; H01J 49/4245; G01N 2030/027

(57) ABSTRACT

A method of determining a calibration for an analytical instrument comprises ionising a calibrant to produce calibrant ions, performing a sequence of ion separation scans, performing a plurality of mass analysis scans by performing one or more mass analysis scan(s) during each ion separation scan of the sequence, and using data obtained from the plurality of mass analysis scans to determine a calibration for the analytical instrument. Each ion separation scan has a duration T_{IMS}, and each mass analysis scan has a duration T_{MA}. Each ion separation scan has a respective start time tⁱ₀, and each mass analysis scan has a respective start time t^{ij}_{MA} defined relative to the start time tⁱ₀ of the ion separation scan during which the mass analysis scan is performed. The start times t^{ij}_{MA} of the plurality of mass analysis scans include start times separated by a delay time Δt, wherein Δt<min (T_{MA}, T_{IMS}).

### CROSS REFERENCE TO RELATED APPLICATION

This application claims priority to U.S. Provisional Patent Application No. 63/468,170, filed May 22, 2023, and is incorporated herein by reference.

### FIELD OF THE INVENTION

The present invention relates to the field of mass spectrometry, and in particular to Fourier transform (FT) mass spectrometry using electrostatic traps such as electrostatic orbital traps.

### BACKGROUND

Fourier transform mass spectrometry (FT-MS) utilises transient acquisitions on timescales of tens or hundreds of milliseconds to multiple seconds, while high resolution ion mobility (IM) devices can produce arrival time distributions of ions that are one to tens of milliseconds wide. Owing to this time mismatch, when FT-MS is used as the detector for high resolution ion mobility separation, ion packets of different ions which are separated in ion mobility space can be detected in the same FT-MS acquisition bin, eliminating the separation achieved with ion mobility. This problem is compounded when the combination of FT-MS and high-resolution IM is applied to proteomic workflows.

It is believed that there remains scope for improvements to apparatus and methods for mass analysis.

### SUMMARY

A first aspect provides a method of determining a calibration for an analytical instrument, the analytical instrument comprising:
an ion separator configured to perform ion separation scans, wherein in each ion separation scan the ion separator receives ions and separates them according to a first physico-chemical property, wherein each ion separation scan has a duration T_{IMS}; and
a mass analyser arranged downstream of the ion separator, wherein the mass analyser is configured to perform mass analysis scans, wherein in each mass analysis scan the mass analyser receives ions and mass analyses them, wherein each mass analysis scan has a duration T_{MA};
the method comprising:
(i) ionising a calibrant to produce calibrant ions;
(ii) the ion separator performing a sequence of ion separation scans, wherein in each ion separation scan the ion separator receives calibrant ions and separates them according to the first physico-chemical property, and wherein each ion separation scan has a respective start time to; and
(iii) the mass analyser performing a plurality of mass analysis scans, wherein in each mass analysis scan the mass analyser receives separated calibrant ions and mass analyses them, wherein the mass analyser performs the plurality of mass analysis scans by performing one or more mass analysis scan(s) during each ion separation scan of the sequence, and wherein each mass analysis scan has a respective start time t^{ij}_{MA} defined relative to the start time tⁱ₀ of the ion separation scan during which the mass analysis scan is performed;
wherein start times t^{ij}_{MA} of the plurality of mass analysis scans include start times separated by a delay time Δt, wherein Δt<min(T_{MA}, T_{IMS});
the method further comprising:
(iv) using data obtained from the plurality of mass analysis scans to determine a calibration for the analytical instrument.

Embodiments are directed to methods of determining a calibration for an analytical instrument such as a mass spectrometer. The instrument includes an ion separator configured to separate ions according to a first physico-chemical property, and a mass analyser arranged downstream of the ion separator and configured to receive and mass analyse ions separated by the ion separator. The ion separator may be an ion mobility separator, a differential ion mobility separator, or a device configured to separate ions according to their mass to charge ratio (m/z).

The ion separator is operable in a cyclical manner, i.e. so as to repeatedly perform ion separation scans, with each scan having a first duration, i.e. “scan time” T_{IMS}. Similarly, the mass analyser is operable in a cyclical manner, i.e. so as to repeatedly perform mass analysis scans, with each scan having a second different duration, i.e. “scan time” T_{MA}.

In some embodiments, the second duration is less than or equal to the first duration, i.e. T_{MA}≤T_{IMS}, e.g. so that multiple mass analysis scans may be performed during each ion separation scan.

In embodiments, the mass analyser is of a type in which the mass analyser scan time T_{MA} is relatively long, e.g. such that only tens or a few hundreds of mass analysis scans can be performed during each ion separation scan. In particular embodiments, the mass analyser is a Fourier Transform (FT) mass analyser, such as an electrostatic orbital trap mass analyser, and more specifically an Orbitrap™ FT mass analyser as made by Thermo Fisher Scientific. Fourier Transform mass analysers utilise transient acquisitions on the timescale of tens or hundreds of milliseconds to multiple seconds, while ion separators produce arrival time distributions of ions that are one to tens of milliseconds wide. Owing to this time mismatch, ions separated in the first physico-chemical property (e.g. ion mobility) space could be detected in the same mass analysis scan, eliminating the separation achieved by the ion separator.

Although embodiments described herein focus mainly on more significant applications where the mass analysis duration T_{MA} is significantly shorter than the ion separation duration T_{IMS}, it should be noted that the method also works when the condition T_{MA}≤T_{IMS} is not fulfilled, i.e. when the ion separation duration Tis is shorter than a single mass analysis scan. Thus, in some embodiments the first duration may be less than or equal to the second duration, i.e. T_{IMS}≤T_{MA}.

Embodiments provide a method of determining a calibration for the instrument, which can be used to address the above problem. The calibration is made by ionising a calibrant to produce calibrant ions, performing a sequence of ion separation scans, and performing a plurality of mass analysis scans by performing one or more mass analysis scan(s) during each ion separation scan of the sequence. Each ion separation scan has a respective start time tⁱ₀, and each mass analysis scan has a respective start time t^{ij}_{MA} defined relative to the start time tⁱ₀ of the ion separation scan during which the mass analysis scan is performed (and so each mass analysis scan has a respective start time (tⁱ₀+t^{ij}_{MA})).

The start times t^{ij}_{MA} of the plurality of mass analysis scans include start times separated by a delay time Δt, wherein Δt<min(T_{MA}, T_{IMS}). That is, the delay time Δt is less than (e.g. much less than) the smaller duration of the mass analysis duration T_{MA} and the ion separation duration T_{IMS}. In other words, at least some of the mass analysis scans have start times (defined relative to the start time tⁱ₀ of the ion separation scan during which the mass analysis scan is performed) which are separated by a delay time Δt which is less than the duration T_{MA} of the mass analysis scans when T_{MA}≤T_{IMS}, or which is less than the duration T_{IMS} of the ion separation scans when T_{IMS}≤T_{MA}. This means that the plurality of mass analysis scans provides data that has a relatively high time resolution (i.e. higher than would be the case if the mass analyser were conventionally synchronised with the ion separator), and thereby the granularity of the first physico-chemical property (e.g. ion mobility) time determination is improved.

The data obtained from the plurality of mass analysis scans is used to determine a calibration for the analytical instrument. In particular, and as is described in more detail below, the data may be used to determine an ion arrival time versus m/z and charge state (z) and/or chemical class calibration for the calibrant ions. Then, when analysing sample ions, the calibration can be used to determine an expected ion arrival time for sample ions depending on the m/z and charge state and/or chemical class of the sample ions. As is described in more detail below, this information can be used to avoid loss of ion separation when mass analysing ions separated by the ion separator.

It will be appreciated, therefore, that embodiments provide improved methods of operating analytical instruments.

The analytical instrument may be a mass spectrometer, e.g. comprising an ion source. Ions may be generated from a calibrant or sample in the ion source. Ions may be passed from the ion source to the ion separator optionally via one or more ion optical devices arranged between the ion source and the ion separator.

The ion separator is configured to perform ion separation scans to separate ions received from the ion source according to the first physico-chemical property. The ion separator may be an ion mobility separator, in which case each ion separation scan is an ion mobility separation scan and the first physico-chemical property is ion mobility. Alternatively, the ion separator may be a differential ion mobility separator, in which case each ion separation scan is a differential ion mobility separation scan and the first physico-chemical property is differential ion mobility. Alternatively, the ion separator may be a device configured to separate ions according to their mass to charge ratio (m/z), in which case each ion separation scan is a mass to charge ratio (m/z) separation scan and the first physico-chemical property is mass to charge ratio (m/z). Further details of various possible types of ion separators are provided below.

The ion separator may be operable in a cyclical manner, i.e. to repeatedly perform ion separation scans. In each ion separation scan the ion separator receives ions from the ion source, and e.g. accumulates a packet of ions in an accumulation region. Alternatively, packets of ions may be accumulated in an ion trap upstream of the ion separator. The ion separator then separates the packet of ions according to the ions' first physico-chemical property, e.g. by passing the packet of ions through an ion separation region. Ions with a higher value of the first physico-chemical property reach the end of the ion separation region (and leave the separator) ahead of ions with a lower value of the first physico-chemical property (or vice versa).

Each ion separation scan has a duration T_{IMS}. In other words, the ion separator has a cycle time T_{IMS}. The duration T_{IMS} may include the time required to accumulate a packet of ions together with the time required to separate ions. Alternatively, the duration T_{IMS} may correspond only to the time required to separate ions, where the accumulation of a packet of ions is performed in parallel with the separation of a previously accumulated packet of ions. The duration T_{IMS} may be on the order of hundreds or a few thousands of milliseconds. The duration T_{IMS} may be constant within any given experiment, but may be varied between experiments by suitable control of the instrument.

The mass analyser is configured to perform mass analysis scans to determine the mass to charge ratio (m/z) of ions. The mass analyser may be operable in a cyclical manner, i.e. to repeatedly perform mass analysis scans. In each mass analysis scan the mass analyser receives ions and mass analyses them. In embodiments, the mass analyser is an ion trap mass analyser, such as an electrostatic orbital trap, and more specifically an Orbitrap™ FT mass analyser.

It would be possible for the instrument to be configured such that ions may be passed to the mass analyser in the form of an ion beam, e.g. without having been accumulated before being passed to the mass analyser. Thus, in embodiments, ions are accumulated directly within the mass analyser. In these embodiments, the number of ions accumulated within the mass analyser may be controlled by controlling an accumulation time (e.g. fill time) of ions into the mass analyser. This in turn may be controlled by operating a gate or lens of the mass analyser and/or a gate or lens within the instrument upstream of the mass analyser (between the ion source and the mass analyser) in an open (transmitting) mode of operation for a desired amount of time (and otherwise operating the gate or lens in a closed (non-transmitting) mode of operation).

However, in particular embodiments, ions are passed to the mass analyser from an ion trap arranged upstream of the mass analyser. Ions may be initially accumulated within the ion trap, and then passed to the mass analyser, e.g. in the form of a packet of ions. The ion trap may be referred to as an injection device for injecting ions into the mass analyser. The ion trap can comprise any suitable ion trap, such as a linear ion trap or a curved linear ion trap (C-trap), e.g. as described WO 2008/081334. The ion trap may be used to cool the accumulated ions prior to injecting them into the mass analyser. The ion trap may also or instead be used (in an MS² mode of operation) to fragment ions prior to injecting the fragment ions into the mass analyser. Multiple ion traps could also be used, e.g. as described in co-pending application GB2114780.6.

In these embodiments, the number of ions accumulated within the mass analyser may be controlled by controlling an accumulation time (e.g. fill time) of ions into the ion trap. This in turn may be controlled by operating a gate or lens of the ion trap and/or a gate or lens within the instrument upstream of the ion trap (between the ion source and the ion trap) in an open (transmitting) mode of operation for a desired amount of time (and otherwise operating the gate or lens in a closed (non-transmitting) mode of operation).

Each mass analysis scan has a duration T_{MA}. In other words, the mass analyser has a cycle time T_{MA}. T_{MA} may include all overheads linked to operation of the mass analyser. The duration T_{MA} may include the time required to accumulate a packet of ions (and optionally to cool and/or fragment those ions, and optionally to inject those ions into the mass analyser) together with the time required to mass analyses those ions. Alternatively, the duration T_{MA} may correspond only to the time required to mass analyse a packet of ions, or only the time required to accumulate a packet of ions (and optionally to cool and/or fragment those ions), where the accumulation of a packet of ions is performed in parallel with the mass analysis of a previously accumulated packet of ions.

In particular embodiments, the mass analysis scan time T_{MA} is less than (or equal to) the ion separation scan time T_{IMS}. However, the method works well even if this condition is not uphold. In embodiments, the mass analyser is of a type in which the mass analyser scan time T_{MA} is relatively long, e.g. such that only tens or a few hundreds of mass analysis scans can be performed during each ion separation scan. The duration T_{MA} may be on the order of tens or hundreds of milliseconds. The duration T_{MA} may be constant within any given experiment, but may be varied between experiments by suitable control of the instrument.

The method comprises ionising a calibrant to produce calibrant ions. The calibrant may be selected to be representative of a sample that is to be analysed. In other words, the calibrant may be of the same or a similar chemical class as the sample to be analysed. Examples of a chemical class include peptides derived from tryptic digestion of a protein; a group or mixture of proteins; lipids or a group of lipids; metabolites or a group of metabolites; nucleotides, and so on. The calibrant may be of a single chemical class (in which case the calibrant should be of the same class as the sample to be analysed), or may comprise a mixture of chemical classes (e.g. peptides and lipids), in which case the mixture should include compounds of the same class as the sample(s) to be analysed. It would also be possible to make multiple calibrations in respect of multiple calibrants each of one or more different chemical class(es), and to combine the results of the multiple calibrations into a single calibration. Where a new class of sample is to be analysed, a new calibration may be made using a different calibrant that is representative of the new sample. As is described in more detail below, this ensures that the calibration is useful when analysing sample ions.

In the method, the ion separator performs a sequence of ion separation scans, wherein in each ion separation scan the ion separator receives calibrant ions and separates them according to the first physico-chemical property. At the same time, the mass analyser performs a plurality of mass analysis scans, wherein in each mass analysis scan the mass analyser receives separated calibrant ions and mass analyses them. Each of the mass analysis scans may be an MS¹ mass analysis scan, wherein ions produced by the ion source are not (intentionally) fragmented before being mass analysed. Each of the mass analysis scans may determine the mass to charge ratio (m/z) of ions within a m/z range of interest, e.g. between about 100 and 2000 or similar.

The mass analyser performs the plurality of mass analysis scans by performing one or more mass analysis scan(s) during each ion separation scan of the sequence. The mass analyser may perform the plurality of mass analysis scans by performing only one mass analysis scan during each ion separation scan of the sequence, or by performing plural mass analysis scans during each ion separation scan of the sequence.

The sequence of ion separation scans may be a contiguous or non-contiguous sequence of ion separation scans. Similarly, the plurality of mass analysis scans may be performed as a contiguous or non-contiguous sequence of mass analysis scans.

Each ion separation scan has a respective start time to, and each mass analysis scan has a respective start time t^{ij}_{MA} defined relative to the start time to of the ion separation scan during which the mass analysis scan is performed (and so each mass analysis scan has a respective start time (tⁱ₀+t^{ij}_{MA})). Here, i=1,2, . . . I is an integer label for each sequential ion separation scan, and j=1,2, . . . . J is an integer label for each sequential mass analysis scan within an ion separation scan. The sequence of ion separation scans may include/ion separation scans, and J mass analysis scans may be performed during each ion separation scan. The start time tⁱ₀ of each ion separation scan may be defined as the time at which a packet of ions is released from the accumulation region (or ion trap) of the ion separator and injected into the separation region of the ion separator. The start time t^{ij}_{MA} of each mass analysis scan may be defined as the time (after the start time tⁱ₀ of the ion separation scan during which that mass analysis scan is performed) at which the gate or lens upstream of the mass analyser (and optionally upstream of the ion trap from which ions are injected into the mass analyser) is opened so as to start accumulating ions within the mass analyser or within its ion trap for the subsequent mass analysis scan.

In embodiments, the start times t^{ij}_{MA} of the plurality of mass analysis scans include start times separated by a delay time Δt, wherein Δt<<min(T_{MA}, T_{IMS}). In other words, at least some of the mass analysis scans amongst the sequence of ion scans have start times (defined relative to the start time to of the ion separation scan during which the mass analysis scan is performed) which are separated by a delay time Δt which is less than the duration T_{MA} of the mass analysis scans when T_{MA}≤T_{IMS}, or which is less than the duration T_{IMS} of the ion separation scans when T_{IMS}≤T_{MA}. This means that the plurality of mass analysis scans provides data that has a relatively high time resolution (i.e. higher than would be the case if the mass analyser were conventionally synchronised with the ion separator). For the highest resolution, Δt may be less than or equal to the average width of an ion separation peak, although for many real-life applications this is not required. Δt may have duration of around a millisecond, a few milliseconds (e.g. approximately 2 ms) or a few tens of milliseconds. This means that the plurality of mass analysis scans provides data with a sufficiently high time resolution to retain ion separation information.

In embodiments, at least an initial mass analysis scan is performed during each ion separation scan of the sequence, with each initial mass analysis scan having a start time t^{i,1}_{MA} (defined relative tⁱ₀ the start time to of the ion separation scan during which that initial mass analysis scan is performed), wherein start times t^{i,1}_{MA} of the initial mass analysis scans are separated from one another by the delay time Δt. In embodiments, start times of the initial mass analysis scans in sequential ion separation scans are separated by the delay time Δt. Where only one mass analysis scan is performed during each ion separation scan of the sequence, the initial start times t^{i,1}_{MA} may be configured to span most or all of the ion separation scan duration T_{IMS}, e.g. so that most of all of the ion arrival time versus m/z space (i.e. the first physico-chemical property-m/z space) of interest is sampled with a time resolution Δt.

Optionally, a second mass analysis scan is performed during each ion separation scan of the sequence, with each second mass analysis scan having a start time t^{i,2}_{MA} (defined relative to the start time to of the ion separation scan during which that second mass analysis scan is performed), wherein start times t^{i,2}_{MA} of the second mass analysis scans are separated from one another by the delay time Δt. In embodiments, each second mass analysis scan immediately follows each initial mass analysis scan, and so t^{i,2}_{MA}=t^{i,1}_{MA}+T_{MA}. Similarly, a third mass analysis scan may optionally be performed during each ion separation scan of the sequence, with each third mass analysis scan having a start time t^{i,3}_{MA} (defined relative to the start time tⁱ₀ of the ion separation scan during which that third mass analysis scan is performed), wherein start times t^{i,3}_{MA} of the third mass analysis scans are separated from one another by the delay time Δt, and where each third mass analysis immediately follows each second mass analysis scan, such that t^{i,3}_{MA}=t^{i,1}_{MA}+2T_{MA}. One or more further mass analysis scan(s) may optionally be performed during each ion separation scan of the sequence. By performing multiple mass analysis scans during each ion separation scan, fewer ion separation scans are required to sample most or all of the ion arrival time versus m/z space of interest with the time resolution Δt.

Thus, in general, the method may comprise performing a set of multiple mass analysis scans during each ion separation scan of the sequence, with each mass analysis scan having a start time t^{ij}_{MA} (defined relative to the start time to of the ion separation scan during which that mass analysis scan is performed), wherein start times t^{ij}_{MA} of corresponding mass analysis scans from each ion separation scan are separated from one another by the delay time Δt. Each of the multiple mass analysis scans performed during each ion separation scan may immediately follow one another, so t^{ij+1}_{MA}=t^{ij}_{MA}+T_{MA}. The set of multiple mass analysis scans performed during each ion separation scan may together approximately span the entire duration T_{IMS} of that ion separation scan. Thus, the set of multiple mass analysis scans performed during each ion separation scan may include approximately J≈T_{IMS}/T_{MA} mass analysis scans (with start times from t^{i,1}_{MA} to t^{i,J}_{MA}).

The start times t^{i,j}_{MA} of the plurality of mass analysis scans may be configured to span most or all of the ion separation scan duration T_{IMS}, e.g. so that most of all of the ion arrival time versus m/z space of interest is sampled with a time resolution Δt. Thus, the plurality of mass analysis scans may include on the order of I×J≈T_{IMS}/Δt mass analysis scans (with start times from t^{1,1}_{MA} to t^{iJ}_{MA}).

The method may comprise, in each successive ion separation scan of the sequence, increasing (or decreasing) the start time t^{i,1}_{MA} of the initial mass analysis scan performed during that ion separation scan by the delay time Δt. Similarly, the method may comprise, in each successive ion separation scan of the sequence, increasing (or decreasing) the start time t^{i,2}_{MA} of the second mass analysis scan and/or the start time t^{i,3}_{MA} of the third mass analysis scan by the delay time Δt. In embodiments, the delay time Δt is constant in respect of all of the plurality of mass analysis scans. Thus, the method may comprise, in each successive ion separation scan of the sequence, increasing (or decreasing) the start times t^{ij}_{MA} of the mass analysis scans performed during that ion separation scan by a constant delay time Δt, such that most or all of the ion arrival time versus m/z space of interest is sampled with a time resolution Δt.

The method comprises using data obtained from the plurality of mass analysis scans to determine a calibration for the analytical instrument. The calibration may be (i) an ion arrival time versus mass to charge ratio (m/z) and charge state (z) calibration, (ii) an ion arrival time versus mass to charge ratio (m/z), charge state (z) and chemical class calibration, or (iii) an ion arrival time versus mass to charge ratio (m/z) and chemical class calibration. The calibration may be used to determine an expected ion arrival time for sample ions (i) depending on the m/z and charge state of the sample ions, (ii) depending on the m/z, charge state and chemical class of the sample ions, or (iii) depending on the m/z and chemical class of the sample ions.

The plurality of mass analysis scans may be configured to sample most or all of the ion arrival time versus m/z space of interest with a time resolution Δt, and so the data obtained from the plurality of mass analysis scans is in embodiments used to determine the relationship between ion arrival time and m/z for calibrant ions of various different charge states (e.g. singly charged, doubly charged, triply charged, etc.) and/or chemical classes. These relationships may take the form of a “trend line” in respect of each different charge state and/or chemical class. That is, the relationship between ion arrival time and m/z is approximately linear for ions having a particular charge state (and a particular chemical class), and so may be described a trend line, e.g. in the form of a slope and intercept. Non-linear trend lines are also possible, depending on the nature of the sample ions. Thus, the calibration may be in the form of one or more trend lines. Each trend line may correspond to (i) a particular charge state (e.g. singly charged, doubly charged, triply charged, etc.), (ii) a particular combination of charge state and chemical class, or (iii) a particular chemical class. Each trend line may provide a relationship between ion arrival time and m/z for ions having that charge state and/or chemical class. For example, each trend line may provide a relationship between ion mobility arrival time and m/z for ions having that charge state and/or chemical class.

These relationships may be determined from the data by firstly identifying plural different calibrant ions in the data. Each calibrant ion will appear in the data as one or more peaks having respective mass to charge ratio(s), and may appear in a group of contiguous mass analysis scans of the plurality of mass analysis scans (i.e. may appear in the data from a group of plural mass analysis scans that have contiguous start times). The charge state (e.g. singly charged, doubly charged, triply charged, etc.) of each identified calibrant ion may be determined, e.g. based on its isotopic distribution in one or more of the mass analysis scans. Optionally, where the calibrant comprises a mixture of chemical classes, the chemical class of each identified calibrant ion may be determined. (Where, on the other hand, the calibrant is of a single chemical class, the chemical class of each identified calibrant ion is already known). An ion chromatogram (e.g. a plot of intensity versus mass analysis scan start time) may be constructed from the data for each identified calibrant ion, and the ion chromatogram may be used to determine an ion arrival time for each identified calibrant ion. Each trend line may then be determined, e.g. by fitting a line to a plot of the so-determined ion arrival times versus m/z in respect of identified ions of each different charge state and/or chemical class.

It will be understood that in the above-described method, the ion arrival time versus m/z space of interest for calibrant ions is mapped by performing a plurality of mass analysis scans with start times t^{ij}_{MA} separated by a delay time Δt. In alternative embodiments, the ion arrival time versus m/z space of interest can instead be mapped by sweeping a mass filter across an m/z range during each of a sequence of ion separation scans, where the m/z range over which the mass filter is swept is different in respect of each the ion separation scans.

Thus, a second aspect provides a method of determining a calibration for an analytical instrument, the analytical instrument comprising:
an ion separator configured to perform ion separation scans, wherein in each ion separation scan the ion separator receives ions and separates them according to a first physico-chemical property;
a mass filter arranged downstream of the ion separator, wherein the mass filter is operable in a filtering mode of operation, wherein in the filtering mode of operation the mass filter receives ions and transmits only those ions having mass to charge ratios within a m/z transmission window; and
a mass analyser arranged downstream of the mass filter, wherein the mass analyser is configured to perform mass analysis scans, wherein in each mass analysis scan the mass analyser receives ions and mass analyses them;
the method comprising:
(i) ionising a calibrant to produce calibrant ions;
(ii) the ion separator performing a sequence of ion separation scans, wherein in each ion separation scan, the ion separator receives calibrant ions and separates them according to the first physico-chemical property;
(iii) operating the mass filter in its filtering mode of operation so as to filter separated calibrant ions, and during each ion separation scan of the sequence: scanning a centre mass to charge ratio of the m/z transmission window across a respective mass to charge ratio range Δm/zⁱ, wherein the centre mass to charge ratio of the m/z transmission window is scanned across a respective different mass to charge ratio range Δm/zⁱ for each ion separation scan of the sequence;
(iv) the mass analyser performing a plurality of mass analysis scans by performing one or more mass analysis scan(s) during each ion separation scan of the sequence, wherein in each mass analysis scan the mass analyser receives filtered calibrant ions and mass analyses them; and
(v) using data obtained from the plurality of mass analysis scans to determine a calibration for the analytical instrument.

These aspects and embodiments can be, and in embodiments are, combined with any one or more or each of the aspects, embodiments and/or optional features described herein.

Thus, for example, the ion separator and the mass analyser may be configured as described above. Each ion separation scan may have a duration T_{IMS}, and each mass analysis scan may have a duration T_{MA}, e.g. as described above. However, the start times t^{ij}_{MA} of the mass analysis scans need not be (and in embodiments are not) separated by a delay time Δt.

In embodiments, a mass filter is arranged between the ion separator and the mass analyser, and is configured to receive separated ions from the ion separation (optionally via one or more intermediate parts of the instrument) and to onwardly transmit ions to the mass analyser (optionally via one or more intermediate parts of the instrument). The mass filter can be any suitable mass filter that is operable to filter ions according to their m/z, such as a quadrupole mass filter. The mass filter is configured, when operating in a filtering mode of operation, to onwardly transmit only those ions having mass to charge ratios within a m/z transmission window. The width and/or the centre m/z of the transmission window may be controllable (variable), e.g. by suitable control of RF and/or DC voltage(s) applied to the mass filter.

In these aspects and embodiments, the width of the m/z window is constant throughout the sequence of ion separation scans. For example, the m/z transmission window may have a width between around 10 Th and 100 Th. However, it would be possible for the m/z transmission window width to be varied, and for other widths to be used.

In these aspects and embodiments, the ion separator again performs a sequence of ion separation scans, and at the same time the mass analyser performs a plurality of mass analysis scans, e.g. where multiple mass analysis scans are performed during each ion separation scan. In addition, during each ion separation scan of the sequence, the centre mass to charge ratio of the mass filter's m/z transmission window is scanned across a respective mass to charge ratio range Δm/zⁱ. Here, i=1,2, . . . I is again an integer label for each sequential ion separation scan of the sequence of n ion separation scans. This means that the centre m/z of the mass filter's transmission window will be different for each mass analysis scan of the multiple mass analysis scans performed during an ion separation scan. As such, the mass analysis scans performed during an ion separation scan will each sample (and mass analyse) ions having different ion arrival times, and having different mass to charge ratio ranges. Thus, the multiple mass analysis scans performed during an ion separation scan will in effect sample a sub-region of the ion arrival time versus m/z space of interest.

In these aspects and embodiments, the centre mass to charge ratio of the m/z transmission window is scanned across a different mass to charge ratio range Δm/zⁱ for each ion separation scan of the sequence. Thus, the data acquired during each ion separation scan will in effect sample a different sub-region of the ion arrival time versus m/z space of interest. By appropriate selection of the mass to charge ratio ranges Δm/zⁱ, most or all of the ion arrival time versus m/z space of interest can be mapped in this way. Thus, in these aspects and embodiments, most or all of the ion arrival time versus m/z space of interest is mapped by sweeping a mass filter across an m/z range during each of a sequence of ion separation scans, where the m/z range over which the mass filter is swept is different in respect of each of the ion separation scans.

Each m/z range Δm/zⁱ will have a minimum m/z and a maximum m/z, i.e. where the mass filter's centre m/z is set at the minimum m/z during the initial (or final) mass analysis scan of the multiple mass analysis scans performed during an ion separation scan, and where the mass filter's centre m/z is set at the maximum m/z during the final (or initial) mass analysis scan of the multiple mass analysis scans performed during an ion separation scan (and where the mass filter's centre m/z is scanned between the minimum m/z and the maximum m/z during the intermediate mass analysis scans of the multiple mass analysis scans performed during an ion separation scan).

The minimum m/z and maximum m/z in respect of each of the m/z ranges Δm/zⁱ may be selected so that each of the m/z ranges Δm/zⁱ is different from each other m/z range. Relatively large m/z ranges may provide data that spans a relatively large proportion of the m/z range of interest, but that spans a relatively small proportion of the ion separation scan duration T_{IMS}. In contrast, relatively small m/z ranges may provide data that spans a relatively large proportion of the ion separation scan duration T_{IMS}, but that spans a relatively small proportion of the ion the m/z range of interest. By appropriate selection of the m/z ranges Δm/zⁱ (i.e. by appropriate selection of their minimum m/z and/or maximum m/z), the combined data from the sequence of ion separation scans may be configured to sample most or all of the ion arrival time versus m/z space of interest.

As such, the data obtained from the plurality of mass analysis scans in these aspects and embodiments can again be used to determine the relationship between ion arrival time and m/z for calibrant ions of various different charge states (e.g. singly charged, doubly charged, triply charged, etc.) and/or chemical classes, e.g. in a corresponding manner to that described above.

It will be understood that various embodiments provide a calibration, e.g. in the form of one or more trend lines, with each trend line corresponding to a particular charge state (e.g. singly charged, doubly charged, triply charged, etc.) and/or chemical class, and each trend line providing a relationship between ion arrival time and m/z for ions having that charge state and/or that chemical class.

The calibration may be used as desired. In particular embodiments, when analysing sample ions, the calibration is used to determine an expected ion arrival time for sample ions depending on the m/z and charge state and/or chemical class of the sample ions. This information can be used to avoid loss of ion separation when mass analysing ions separated by the ion separator. In particular, the calibration may be used to determine an acquisition order for precursors in an MS² data directed acquisition (DDA) experiment.

Thus, a further aspect provides a method of operating an analytical instrument, the analytical instrument comprising:
an ion separator configured to perform ion separation scans, wherein in each ion separation scan the ion separator receives ions and separates them according to a first physico-chemical property; and
a mass analyser arranged downstream of the ion separator, wherein the mass analyser is configured to perform mass analysis scans, wherein in each mass analysis scan the mass analyser receives ions and mass analyses them;
the method comprising:
(i) ionising a sample to produce sample ions;
(ii) mass analysing sample ions in an MS¹ mode of operation, so as to produce an MS¹ spectrum of the sample ions;
(iii) identifying a plurality of precursors of interest in the MS¹ mass spectrum;
(iv) determining an acquisition order for acquiring MS² spectra of the plurality of precursors of interest, wherein the acquisition order is determined using an expected ion arrival time for each precursor of interest, and wherein the expected ion arrival time for each precursor of interest is determined using a calibration for the analytical instrument; and
(iv) acquiring MS² spectra for the plurality of precursors of interest by:
   sequentially selecting, in the acquisition order, each precursor of the plurality of precursors of interest; and
   for each selected precursor: fragmenting precursor ions so as to produce fragment ions, and mass analysing the fragment ions so as to produce an MS² spectrum for that precursor.

In these aspects and embodiments, a sample is ionised, and the resulting sample ions are mass analysed to produce an MS¹ spectrum of the sample ions. A plurality of precursors of interest are identified in the MS¹ mass spectrum, and then MS² spectra are acquired for each of the identified precursors of interest.

The order in which the precursors' MS² spectra are acquired is determined based on an expected ion arrival time for each of the precursors of interest. In other words, the method uses an expected ion arrival time-based acquisition order for the precursor MS² spectra. The expected ion arrival time for each precursor of interest is, in turn, determined using a calibration for the analytical instrument, such as in particular the calibration determined using the above-described method(s). In this way, the acquisition order may be configured such that the MS² spectrum in respect of a given precursor is acquired at a time during an ion separation scan at which that precursor will be present, thereby avoiding or reducing loss of ion separation information when analysing precursor ions separated by the ion separator.

These aspects and embodiments can be, and in embodiments are, combined with any one or more or each of the aspects, embodiments and/or optional features described herein. For example, the ion separator and the mass analyser may be configured as described above. Each ion separation scan may have a duration T_{IMS}, and each mass analysis scan may have a duration T_{MA}, e.g. as described above.

In these aspects and embodiments, the sample ions may be mass analysed to produce one or more MS¹ spectra of the sample ions. For example, the method may comprise the ion separator performing an ion separation scan (wherein in each ion separation scan the ion separator receives sample ions and separates them according to the first physico-chemical property), and at the same time the mass analyser performing one or more MS¹ mass analysis scans (wherein in each mass analysis scan the mass analyser receives separated calibrant ions and mass analyses them).

A plurality of precursors of interest may be identified in each MS¹ mass spectrum, and then MS² spectra are acquired for each of the identified precursors of interest. This may comprise the ion separator performing a sequence of one or more further ion separation scans, and at the same time the mass analyser performing a plurality of MS² mass analysis scans. In each MS² scan, a precursor is selected and fragmented to produce fragment ions, and the fragment ions are mass analysed to produce an MS² spectrum for that precursor. The MS² spectra for the plurality of precursors of interest are acquired in an acquisition order that is determined using an expected ion arrival time for each precursor of interest.

A mass filter, such as a quadrupole mass filter, may be arranged between the ion separator and the mass analyser, e.g. as described above. The mass filter may be operated in a transmissive mode of operation when an MS¹ spectrum is being acquired. The mass filter may be operated in its filtering mode of operation when an MS² spectrum is being acquired. Thus, the step of selecting a precursor may comprise operating the mass filter in its filtering mode of operation, e.g. with relatively narrow transmission window (e.g. of around ≤2 Th), and setting the centre m/z of the mass filter's transmission window at the m/z of the precursor. Similarly, the step of sequentially selecting each precursor of the plurality of precursors of interest may comprise sequentially setting the centre m/z of the mass filter's transmission window at the m/z of each precursor (in the acquisition order).

Each MS¹ mass analysis scan may have a duration T_{MS1}, and each MS² mass analysis scan may have a duration T_{MS2}. Typically, T_{MS1}>T_{MS2} because high resolution data is relatively more important for the MS¹ scans, while high speed is relatively more important for the MS² scans (e.g. so that a much larger number of MS² scans can be acquired per unit time). Where the instrument is operated in a cyclical manner, typically T_{MS2} may be set as some fraction of T_{MS1}, e.g. T_{MS2}/T_{MS1}=½, ¼, ⅛, etc.

In the method, the acquisition order is determined using an expected ion arrival time for each precursor of interest, and the expected ion arrival time for each precursor of interest is in turn determined using the calibration for the analytical instrument.

As described above, the calibration may be an ion arrival time versus m/z and charge state (z) and/or chemical class calibration, e.g. in the form of one or more trend lines, with each trend line corresponding to a particular charge state (e.g. singly charged, doubly charged, triply charged, etc.) and/or chemical class, and each trend line providing a relationship between ion arrival time and m/z for ions having that charge state and/or that chemical class. Thus, the calibration may be used to determine an expected ion arrival time for a given precursor based on the m/z and charge state and/or chemical class of that precursor. In other words, using the calibration to determine an expected arrival time for a precursor may comprise using the m/z and the charge state and/or chemical class of the precursor to determine an expected arrival time from the calibration.

It would be possible for the acquisition order to be determined simply by arranging the precursors in order of expected arrival time. However, the MS² mass analysis scans, although shorter than the MS¹ scans, still have a relatively long duration T_{MS2} when compared with the arrival time distributions of separated ions, and so this simple ordering may result in some precursors of interest being missed.

To address this, in embodiments, the MS² spectra for all of the precursors of interest may be acquired during multiple ion separation scans. Multiple MS² mass analysis scans may be performed during each ion separation scan, where the start times t^{ij}_{MS2} (defined relative to the start time tⁱ₀ of the ion separation scan during which the MS² mass analysis scan is performed) of corresponding MS² mass analysis scans in different ion separation scans are synchronised with one another (i.e. are equal, and are not separated by a delay time Δt).

The ion separation scan duration Tis may be divided into a plurality of time periods, with each time-period corresponding to a respective MS² mass analysis scan. For example, there may be an initial time-period corresponding to each initial MS² mass analysis scan of the multiple MS² mass analysis scans performed during each ion separation scan, a second time-period corresponding to each second MS² mass analysis scan, a third time-period corresponding to each third MS² mass analysis scan, and so on.

Each precursor of interest may be assigned to one of the time-periods according to the expected arrival time for that precursor. This may result in multiple precursors being assigned to the same time-period. It would be possible to co-isolate and co-fragment multiple precursors that fall into the same time-period. Additionally or alternatively, when determining the acquisition order, only one precursor from each of the time-periods may be selected in respect of each ion separation scan. Where, after one or more ion separation scans, there are remaining precursors for a given time-period, the MS² spectra for these precursors may be acquired during subsequent ion separation scan(s).

Thus, acquiring MS² spectra for the plurality of precursors of interest may comprise the ion separator performing multiple ion separation scans, wherein each ion separation scan has a duration T_{IMS}, and wherein each ion separation scan duration T_{IMS} is divided into a plurality of time periods each corresponding to an MS² mass analysis scan. The acquisition order may define an acquisition order across the multiple ion separation scans, and may be configured such that each precursor is selected during one of the time-periods, optionally such that a single precursor is selected during each time-period of each ion separation scan (so that a single precursor is selected for each MS² mass analysis scan).

Where there are multiple precursors of interest assigned to the same time-period, the MS² spectra for these precursors may be acquired during multiple ion separation scans. In this case, the precursors assigned to the same time-period may be ordered in any suitable manner, such as for example, according to their intensity.

It will be understood that various embodiments make use of the calibration to determine an acquisition order for precursors in an MS² data directed acquisition (DDA) experiment. In further embodiments, the calibration may also or instead be used to assess the operational state of the ion separation device.

Thus, a further aspect provides a method of operating an analytical instrument, the analytical instrument comprising:
an ion separator configured to perform ion separation scans, wherein in each ion separation scan the ion separator receives ions and separates them according to a first physico-chemical property, wherein each ion separation scan has a duration T_{IMS}; and
a mass analyser arranged downstream of the ion separator, wherein the mass analyser is configured to perform mass analysis scans, wherein in each mass analysis scan the mass analyser receives ions and mass analyses them, wherein each mass analysis scan has a duration T_{MA};
the method comprising:
(i) ionising a calibrant to produce calibrant ions;
(ii) the ion separator performing a sequence of ion separation scans, wherein in each ion separation scan the ion separator receives calibrant ions and separates them according to the first physico-chemical property, and wherein each ion separation scan has a respective start time tⁱ₀; and
(iii) the mass analyser performing a plurality of mass analysis scans, wherein in each mass analysis scan the mass analyser receives separated calibrant ions and mass analyses them, wherein the mass analyser performs the plurality of mass analysis scans by performing one or more mass analysis scan(s) during each ion separation scan of the sequence, and wherein each mass analysis scan has a respective start time t^{ij}_{MA} defined relative to the start time tⁱ₀ of the ion separation scan during which the mass analysis scan is performed;
wherein start times t^{ij}_{MA} of the plurality of mass analysis scans include start times separated by a delay time Δt, wherein Δt<min(T_{MA}, T_{IMS});
the method further comprising:
(iv) using data obtained from the plurality of mass analysis scans to assess the operational state of the ion separator.

A more general aspect provides a method of operating an analytical instrument, the analytical instrument comprising:
an ion separator configured to perform ion separation scans, wherein in each ion separation scan the ion separator receives ions and separates them according to a first physico-chemical property, wherein each ion separation scan has a duration T_{IMS}; and
a mass analyser arranged downstream of the ion separator, wherein the mass analyser is configured to perform mass analysis scans, wherein in each mass analysis scan the mass analyser receives ions and mass analyses them, wherein each mass analysis scan has a duration T_{MA};
the method comprising:
(i) ionising a calibrant to produce calibrant ions;
(ii) the ion separator performing a sequence of ion separation scans, wherein in each ion separation scan the ion separator receives calibrant ions and separates them according to the first physico-chemical property, and wherein each ion separation scan has a respective start time to; and
(iii) the mass analyser performing a plurality of mass analysis scans, wherein in each mass analysis scan the mass analyser receives separated calibrant ions and mass analyses them, wherein the mass analyser performs the plurality of mass analysis scans by performing one or more mass analysis scan(s) during each ion separation scan of the sequence, and wherein each mass analysis scan has a respective start time t^{ij}_{MA} defined relative to the start time to of the ion separation scan during which the mass analysis scan is performed;
wherein start times t^{ij}_{MA} of the plurality of mass analysis scans include start times separated by a delay time Δt, wherein Δt<min(T_{MA}, T_{IMS});
the method further comprising:
(iv) using data obtained from the plurality of mass analysis scans to determine a calibration for the analytical instrument; and/or
(v) using data obtained from the plurality of mass analysis scans to assess the operational state of the ion separator.

These aspects and embodiments can be, and in embodiments are, combined with any one or more or each of the aspects, embodiments and/or optional features described herein. Thus, for example, the ion separator and the mass analyser may be configured and operated as described above.

The step of using data obtained from the plurality of mass analysis scans to assess the operational state of the ion separator may comprise identifying one or more calibrant ions in the data, e.g. in the manner described above with respect to the determination of the calibration. An ion chromatogram (e.g. a plot of intensity versus mass analysis scan start time) may be constructed from the data for each identified calibrant ion, and the ion chromatogram may be used to determine an ion arrival time distribution for each identified calibrant ion. The ion arrival time distribution may then be compared to an expected ion arrival time distribution in order to determine whether the ion separator is in a normal operational state, or is in an abnormal operational state (and so may be in need of adjustment, calibration or repair).

This may comprise, e.g., determining the arrival time associated with the apex of the ion arrival time distribution, and determining the arrival time associated with the weighted average of the ion arrival time distribution. Where these two values differ by less than a threshold amount, then it may be determined that the ion separator is in a normal operational state. Where these two values differ by more than a threshold amount, then it may be determined that the ion separator is in an abnormal operational state.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

A further aspect provides an analytical instrument, such as a mass spectrometer, comprising:
an ion source;
an ion separator arranged downstream of the ion source, wherein the ion separator is configured to perform ion separation scans, wherein in each ion separation scan the ion separator receives ions and separates them according to a first physico-chemical property, wherein each ion separation scan has a duration T_{IMS}; and
a mass analyser arranged downstream of the ion separator, wherein the mass analyser is configured to perform mass analysis scans, wherein in each mass analysis scan the mass analyser receives ions and mass analyses them, wherein each mass analysis scan has a duration T_{MA}; and
a control system configured to:
(i) cause the ion source to ionise a calibrant to produce calibrant ions;
(ii) cause the ion separator to perform a sequence of ion separation scans, wherein in each ion separation scan the ion separator receives calibrant ions and separates them according to the first physico-chemical property, and wherein each ion separation scan has a respective start time tⁱ₀; and
(iii) cause the mass analyser to perform a plurality of mass analysis scans, wherein in each mass analysis scan the mass analyser receives separated calibrant ions and mass analyses them, wherein the mass analyser performs the plurality of mass analysis scans by performing one or more mass analysis scan(s) during each ion separation scan of the sequence, and wherein each mass analysis scan has a respective start time t^{ij}_{MA} defined relative to the start time to of the ion separation scan during which the mass analysis scan is performed;
wherein start times t^{ij}_{MA} of the plurality of mass analysis scans include start times separated by a delay time Δt, wherein Δt<min(T_{MA}, T_{IMS});
wherein the control system is further configured to:
(iv) use data obtained from the plurality of mass analysis scans to determine a calibration for the analytical instrument; and/or
(v) use data obtained from the plurality of mass analysis scans to assess the operational state of the ion separator.

A further aspect provides an analytical instrument, such as a mass spectrometer, comprising:
an ion source;
an ion separator arranged downstream of the ion source, wherein the ion separator is configured to perform ion separation scans, wherein in each ion separation scan the ion separator receives ions and separates them according to a first physico-chemical property;
a mass filter arranged downstream of the ion separator, wherein the mass filter is operable in a filtering mode of operation, wherein in the filtering mode of operation the mass filter receives ions and transmits only those ions having mass to charge ratios within a m/z transmission window;
a mass analyser arranged downstream of the mass filter, wherein the mass analyser is configured to perform mass analysis scans, wherein in each mass analysis scan the mass analyser receives ions and mass analyses them; and
a control system configured to:
(i) cause the ion source to ionise a calibrant to produce calibrant ions;
(ii) cause the ion separator to perform a sequence of ion separation scans, wherein in each ion separation scan, the ion separator receives calibrant ions and separates them according to the first physico-chemical property;
(iii) operate the mass filter in its filtering mode of operation so as to cause the mass filter to filter separated calibrant ions, and during each ion separation scan of the sequence: scan a centre mass to charge ratio of the m/z transmission window across a respective mass to charge ratio range Δm/zⁱ, wherein the centre mass to charge ratio of the m/z transmission window is scanned across a respective different mass to charge ratio range Δm/zⁱ for each ion separation scan of the sequence;
(iv) cause the mass analyser to perform a plurality of mass analysis scans by performing one or more mass analysis scan(s) during each ion separation scan of the sequence, wherein in each mass analysis scan the mass analyser receives filtered calibrant ions and mass analyses them; and
(v) use data obtained from the plurality of mass analysis scans to determine a calibration for the analytical instrument.

A further aspect provides an analytical instrument, such as a mass spectrometer, comprising:
an ion source;
an ion separator arranged downstream of the ion source, wherein the ion separator is configured to perform ion separation scans, wherein in each ion separation scan the ion separator receives ions and separates them according to a first physico-chemical property;
a mass analyser arranged downstream of the ion separator, wherein the mass analyser is configured to perform mass analysis scans, wherein in each mass analysis scan the mass analyser receives ions and mass analyses them; and
a control system configured to:
(i) cause the ion source to ionise a sample to produce sample ions;
(ii) cause the mass analyser to mass analyse sample ions in an MS¹ mode of operation, so as to produce an MS¹ spectrum of the sample ions;
(iii) identify a plurality of precursors of interest in the MS¹ mass spectrum;
(iv) determine an acquisition order for acquiring MS² spectra of the plurality of precursors of interest, wherein the acquisition order is determined using an expected ion arrival time for each precursor of interest, and wherein the expected ion arrival time for each precursor of interest is determined using a calibration for the analytical instrument; and
(iv) cause the instrument to acquire MS² spectra for the plurality of precursors of interest by:
   sequentially selecting, in the acquisition order, each precursor of the plurality of precursors of interest; and
   for each selected precursor: fragmenting precursor ions so as to produce fragment ions, and mass analysing the fragment ions so as to produce an MS² spectrum for that precursor.

These aspects and embodiments can be, and in embodiments are, combined with any one or more or each of the aspects, embodiments and/or optional features described herein.

### DESCRIPTION OF THE DRAWINGS

Various embodiments will now be described in more detail with reference to the accompanying Figures, in which:

FIG. 1 shows schematically a mass spectrometer in accordance with embodiments;

FIG. 2A shows an example arrival time distribution of four differing peptide ion packets, and FIG. 2B shows a corresponding ion mobility arrival time versus m/z distribution;

FIG. 3A illustrates a known “TopN” acquisition order for a data dependent acquisition (DDA) experiment, FIG. 3B shows an ion mobility arrival time versus m/z distribution overlaid with representations of MS² scans configured in accordance with the acquisition order of FIG. 3A, and FIG. 3C shows example mass spectra obtained from the MS² scans of FIG. 3B;

FIG. 4 illustrates a calibration method in accordance with embodiments;

FIG. 5 shows example extracted ion chromatograms plotted as a function of MS¹ scan number;

FIG. 6A shows example “ground truth” extracted ion chromatograms plotted as a function of ion mobility arrival time, and FIG. 6B shows example calibrated extracted ion chromatograms plotted as a function of ion mobility arrival time;

FIG. 7A illustrates a calibration-based acquisition order for a data dependent acquisition (DDA) experiment in accordance with embodiments, FIG. 7B shows an ion mobility arrival time versus m/z distribution overlaid with representations of MS² scans configured in accordance with the acquisition order of FIG. 7A, and FIG. 7C shows example mass spectra obtained from the MS² scans of FIG. 7B;

FIG. 8 shows an arrival time distribution of a tryptic BSA digest;

FIG. 9 shows a plot of ion mobility arrival time versus m/z for ions of different charge states;

FIG. 10 shows a compilation of empirically determined arrival times as determined by traditional ion mobility analysis for ions of different charge states;

FIGS. 11A-11C illustrate an alternative method for acquiring ion mobility arrival time versus m/z data from which a calibration can be determined;

FIG. 12 depicts five representative ion mobility arrival time distributions with varying degrees of tailing;

FIG. 13A shows five representative calibrated arrival time distributions with varying degrees of tailing, and FIG. 13B shows the distributions of FIG. 13A with the apex of each distribution (point) and the weighted average (solid vertical line) indicated; and

FIG. 14 is a plot of the difference between the weighted average and apex for each calibrated arrival time distribution of FIGS. 13A-13B.

### DETAILED DESCRIPTION

Embodiments described herein pertain to the fields of mass spectrometry, dispersive ion separation such as ion mobility and methods of their calibration.

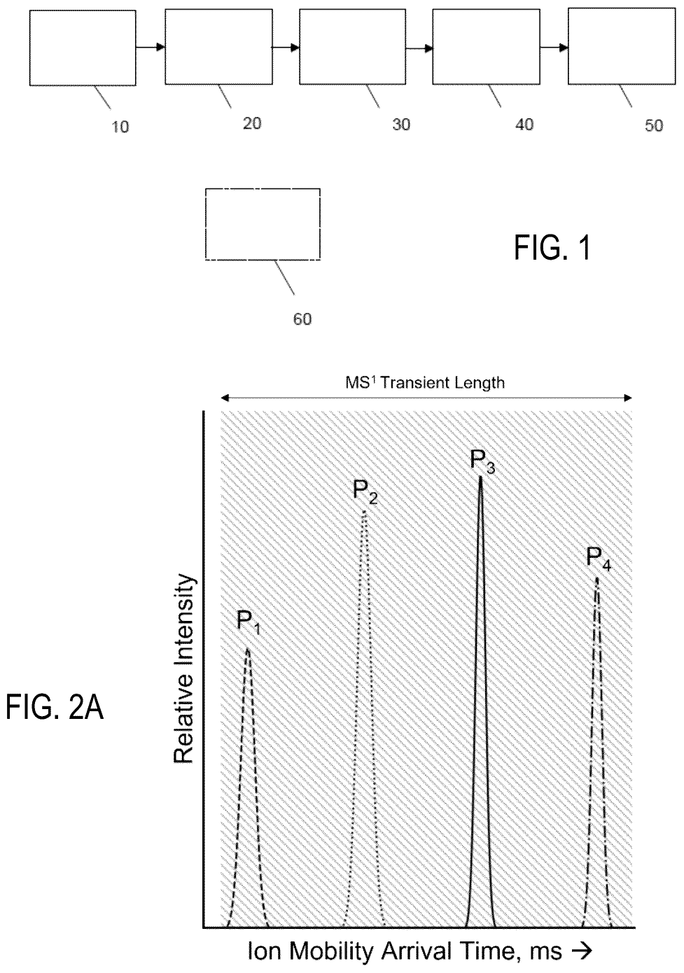

FIG. 1 illustrates schematically an analytical instrument, such as a mass spectrometer, that may be operated in accordance with embodiments. As shown in FIG. 1, the instrument includes an ion source 10, an ion separator 20 such as an ion mobility separator, a mass filter 30, a fragmentation device 40, and a mass analyser 50.

The ion source 10 is configured to generate ions from a sample. The ion source 10 can be any suitable continuous or pulsed ion source, such as an electrospray ionisation (ESI) ion source, a MALDI ion source, and atmospheric pressure ionisation (API) ion source, a plasma ion source, an electron ionisation ion source, a chemical ionisation ion source, and so on. More than one ion source may be provided and used. The ions may be any suitable type of ions to be analysed, e.g. small and large organic molecules, biomolecules, DNA, RNA, proteins, peptides, fragments thereof and the like.

The ion source 10 may optionally be coupled to a separation device such as a liquid chromatography separation device or a capillary electrophoresis separation device (not shown), such that the sample which is ionised in the ion source 10 comes from the separation device.

The ion separator 20 is arranged downstream of the ion source 10, and is configured to receive ions from the ion source 10. The ion separator 20 is configured to separate received ions according to a first physico chemical property. The first physico-chemical property can be, for example, ion mobility, differential ion mobility, or mass to charge ratio (m/z). Various types of ion separator are described in more detail below.

Where the ion separator 20 is an ion mobility separator, the ion mobility separator may comprise any suitable type of ion mobility separator. For example, an electric field, such as a DC voltage gradient and/or a travelling DC voltage wave, may be arranged to urge ions along the length of the separator and through a gas, so that the ions are separated according to their ion mobility. The ions may optionally be urged against a counter flow of gas or perpendicularly to it. Alternatively, a gas flow may be arranged to urge ions along the length of the separator, while an electric field, such as a DC voltage gradient and/or a travelling DC voltage wave, may be arranged to oppose the gas flow so that the ions are separated according to their ion mobility. The ion mobility separator 20 may be a linear separator with a straight or folded path or a cyclic (closed-loop) separator.

The mass filter 30 is arranged downstream of the ion separator 20 and is configured to receive ions from the ion source 10 (via the ion separator 20). The mass filter 30 is configured to filter the received ions according to their mass to charge ratio (m/z). The mass filter 30 may be configured such that received ions having m/z within an m/z transmission window of the mass filter are onwardly transmitted by the mass filter, while received ions having m/z outside the m/z transmission window are attenuated by the mass filter, e.g. are not onwardly transmitted by the mass filter. The width and/or the centre m/z of the transmission window may be controllable (variable), e.g. by suitable control of RF and/or DC voltage(s) applied to the mass filter 30. Thus, for example, the mass filter 30 may be operable in a transmission mode of operation, whereby most or all ions within a relatively wide m/z window are onwardly transmitted by the mass filter 30, and a filtering mode of operation, whereby only ions within a relatively narrow m/z window (centred at a desired m/z) are onwardly transmitted by the mass filter 30. The mass filter 30 can be any suitable type of mass filter, such as a quadrupole mass filter.

The fragmentation device 40 is arranged downstream of the mass filter 30 and is configured to receive most or all ions transmitted by the mass filter 30. The fragmentation device 40 may be configured to selectively fragment some or all of the received ions, i.e. so as to produce fragment ions. The fragmentation device 40 may be operable in a fragmentation mode of operation, whereby most or all received ions are fragmented so as to produce fragment ions (which may then be onwardly transmitted from the fragmentation device 40), and a non-fragmentation mode of operation, whereby most or all received ions are onwardly transmitted without being (deliberately) fragmented. It would also be possible for a non-fragmentation mode of operation to be implemented by causing ions to bypass the fragmentation device 40. The fragmentation device 40 may also be operable in one or more intermediate modes of operation, e.g. whereby the degree of fragmentation is controllable (variable).

The fragmentation device 40 can be any suitable type of fragmentation device, such as for example a collision induced dissociation (CID) fragmentation device, an electron induced dissociation (EID) fragmentation device, a photodissociation fragmentation device, and so on. Numerous other types of fragmentation are possible.

The mass analyser 50 is arranged downstream of the ion separator 20 and is configured to receive ions from the ion source 10 (via the ion separator 20 and mass filter 30, and optionally via the fragmentation device 40). The mass analyser 50 is configured to analyse the received ions so as to determine their mass to charge ratio and/or mass, i.e. to produce a mass spectrum of the ions. The mass analyser 50 may be an ion trap mass analyser, such as an electrostatic orbital trap, and more specifically an Orbitrap™ FT mass analyser.

Thus, the mass analyser 50 may comprise an inner electrode elongated along the orbital trap axis and a split pair of outer electrodes which surround the inner electrode and define therebetween a trapping volume in which ions are trapped and oscillate by orbiting around the inner electrode to which is applied a trapping voltage whilst oscillating back and forth along the axis of the trap. The pair of outer electrodes function as detection electrodes to detect an image current induced by the oscillation of the ions in the trapping volume and thereby provide a detected signal. The outer electrodes typically function as a differential pair of detection electrodes and are coupled to respective inputs of a differential amplifier, which in turn forms part of a digital data acquisition system to receive the detected signal. The detected signal can be processed using Fourier transformation to obtain a mass spectrum of ions within the trap.

It should be noted that FIG. 1 is merely schematic, and that the instrument can, and in embodiments does, include any number of one or more additional components.

For example, the instrument may include one or more ion transfer or trapping stage(s), e.g. arranged between the various illustrated devices. The one or more ion transfer stage(s) may include, e.g., an atmospheric pressure interface and/or one or more ion guides, lenses and/or other ion optical devices configured such that ions can be transferred between the various illustrated devices. The ion transfer stage(s) may include any suitable number and configuration of ion optical devices, for example optionally including one or more RF and/or multipole ion guides, one or more ion guides for cooling ions, one or more mass selective ion guides, and so on.

As also shown in FIG. 1, the instrument is under the control of a control unit 60, such as an appropriately programmed computer, which controls the operation of various components of the instrument. The control unit 60 may also receive and process data from various components including the analyser 50. The control unit 60 is configured, amongst other things, to determine the settings for the mass analyser 60 for analytical scans.

### Data Dependent Analysis Applications

FT-MS utilizes transient acquisitions on timescales of tens or hundreds of milliseconds to multiple seconds, while high resolution IM devices produce arrival time distributions of peptide ions that are a few to tens of milliseconds wide. Owing to this time mismatch, when FT-MS is used as the detector for high resolution ion mobility separation, ion packets of differing ions, which are separated in ion mobility space, can be detected in the same FT-MS acquisition bin, eliminating the separation achieved with ion mobility. This problem is compounded when the combination of FT-MS and high-resolution IM is applied to proteomic workflows.

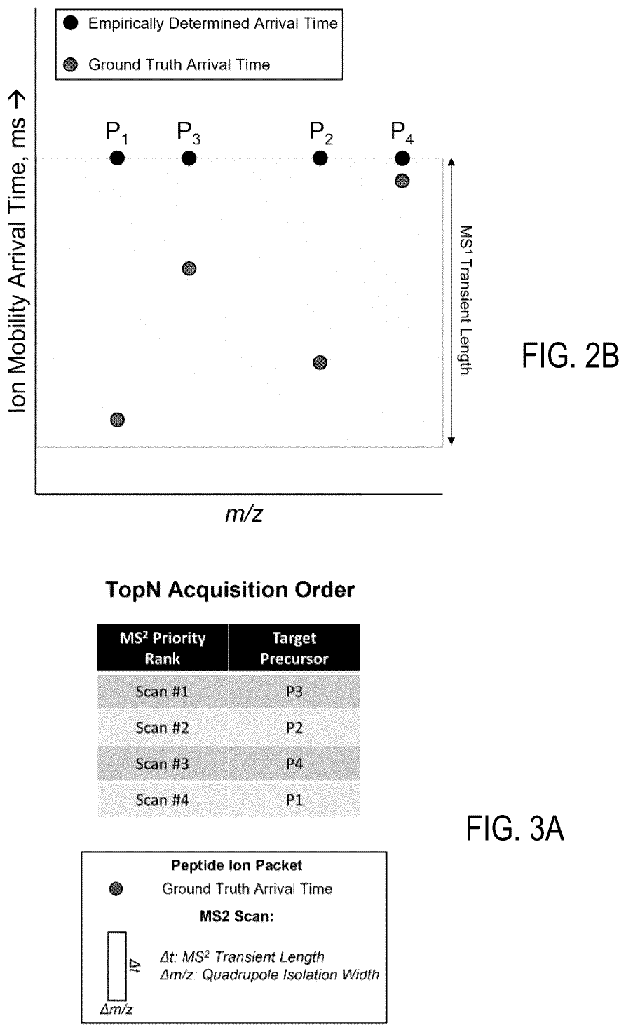

This is illustrated by FIGS. 2A and 2B. FIG. 2A shows the arrival time distribution of four differing example peptide ion packets (P1, P2, P3, P4) which have been separated in the time domain through high resolution IM. However, due to the comparatively long transient length required for MS analysis (grey hatch), these peptide ions fall within the same MS bin and thus the separation is lost. FIG. 2B shows this data in two dimensions, ion mobility arrival time versus m/z. The loss of the IM separation (labelled “Ground Truth Arrival Time”) for the peptide ions can be seen, as all peptides would show an empirical arrival time (labelled “Empirically Determined Arrival Time”) at the end of the MS¹ transient length.

During conventional proteomic workflows, such as data-dependent acquisition (DDA), a mixture of peptide ions is typically separated using liquid chromatography (LC) and then ionized and transported into the mass spectrometer, wherein a MS¹ survey scan generates a list of precursor ions to fragment in subsequent MS² scans. A “Top N” method then ranks the precursors in acquisition order based on decreasing intensity, and then the quadrupole mass filter applies a narrow isolation in m/z space around the target precursor for each subsequent MS² scan until the target list is exhausted, i.e., MS² Scan₁, Scan₂, . . . Scan_{N}.

These conventional methods work well for LC-MS systems as the elution of peptides from an LC column are on the order of multiple seconds and thus allow many MS scans to occur over the peak. However, when these ions are also separated via IM, this two-dimensional separation approach adds complexity as a specific peptide ion species will be concentrated into a single arrival time distribution only a few milliseconds or a few tens of milliseconds wide. The instrument is unable to discern the arrival time of a single peptide distribution with a higher accuracy than the MS¹ transient length, i.e. all ions arriving in one transient bin will be summed together and will be assigned a single “Empirically Determined Arrival Time” (as shown in FIG. 2B).

Thus, when the “Top N” approach is applied and precursors are ranked based on intensity, the instrument can potentially target an ion that is not present at that specific scan time owing to the IM separation, resulting in empty MS² scans and a loss of duty cycle.

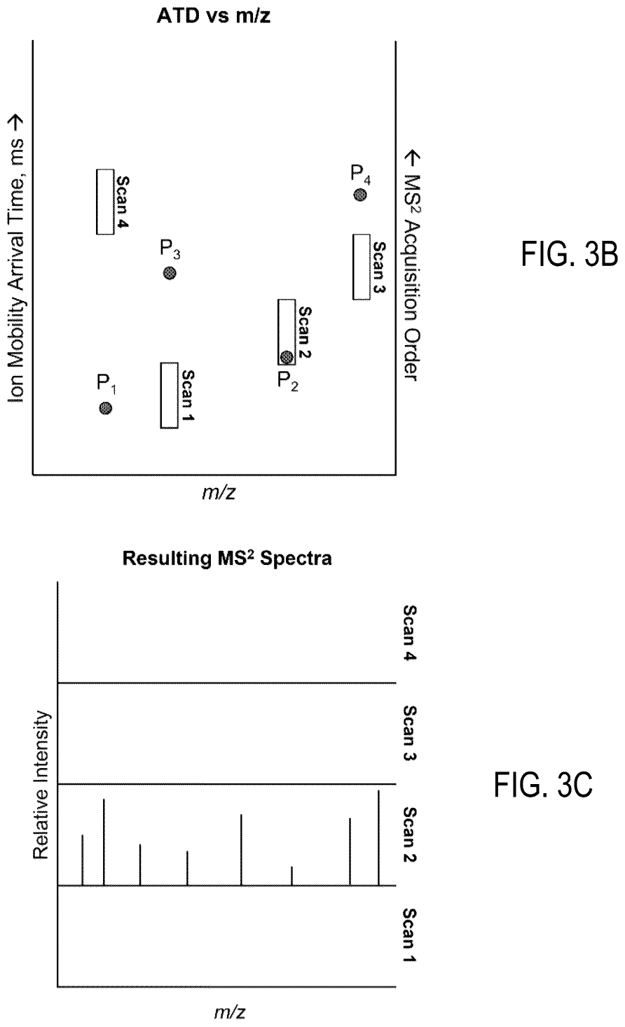

This is illustrated by FIGS. 3A-3C, which show a depiction of a TopN DDA method applied to a LC-IM-MS workflow, where an MS² Priority Rank is determined by relative intensity and prioritized in descending order (“TopN Acquisition Order”, based on the relative intensity shown in FIG. 2A). The “ATD vs m/z” plot of FIG. 3B shows the placement of the sequential MS² scans in the two-dimensional ion mobility arrival time versus m/z space. The resulting MS² spectra are shown in FIG. 3C and indicate that due to the added separation of ion mobility and the lack of resolution in this domain (due to the long transient length of the MS¹ survey scan), a TopN approach can result in several empty spectra. In particular, Scan 1, Scan 3 and Scan 4 result in such spectra, while Scan 2 results in a successful MS² acquisition.

This problem could be reduced by using shorter transient bins in order to minimize the impact of arrival time binning. Through minimizing this effect, the impact on missing precursors in a targeted analysis also decreases. However, the problem is not eliminated and the mass resolution, and thus the ability to resolve overlapping precursor signals in m/z space, would be diminished in turn.

Embodiments described herein provide a calibration procedure that allows increased accuracy in determining the arrival time of various ions in IM arrival time space. This calibration can be applied to a DDA workflow to generate a “Calibration-Based Acquisition Scheme” in place of the traditional TopN method. FIGS. 4 to 6B illustrate the calibration procedure.

As shown in FIG. 4, the calibration procedure takes a known set of analytes, e.g., P1, P2, P3, P4, separates these ions with IM and analyses the arrival time distribution with multiple MS¹ scans over the IM cycle (macro-scan), where MS¹ scans in each subsequent macro-scan are delayed by a known amount (Δt). In other words, in order to determine the arrival time of each peptide more accurately when using long-timescale transient windows, the ion mobility separation is repeated numerous times and the start of the MS¹ scan, and thus the effective arrival time bin analysed, is shifted by a known delay Δt. An MS¹ scan is understood in this context as the opening time of the ion gate that admits ions into a downstream FTMS analyser, and may be shorter than the actual duration of FTMS detection. This process is repeated until the MS¹ scan transient window has reached the estimated maximal arrival time (“MS¹ Scan n”) at the end of macro-scan. In other words, the number of MS¹ scans is repeated at increasingly long delays until the sliding transient window reaches the desired maximal arrival time “MS¹ Scan n”.

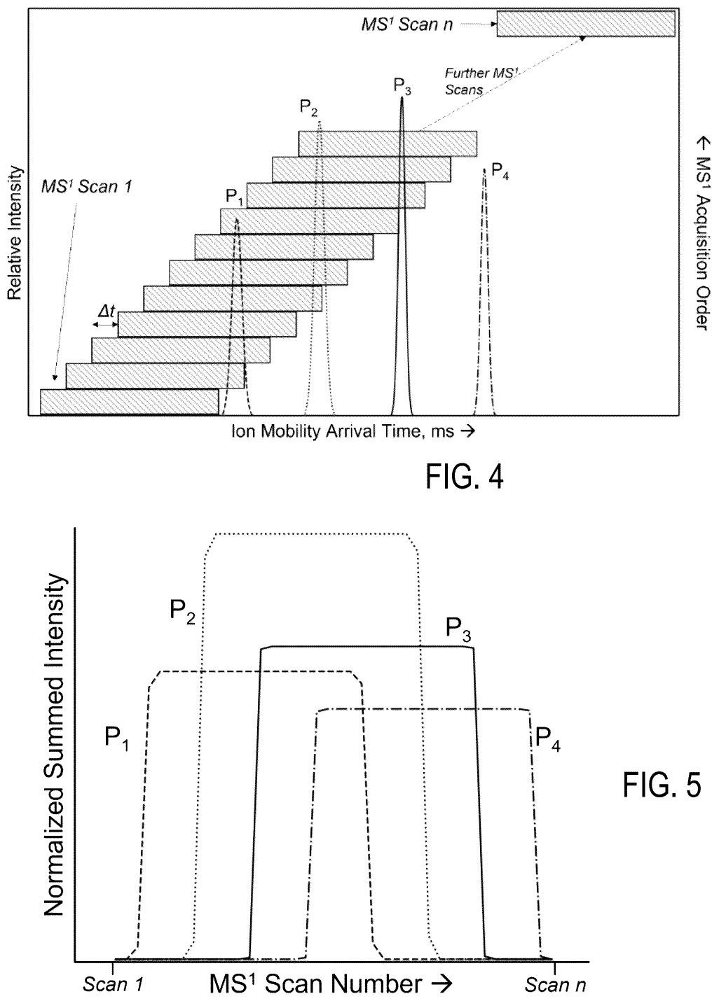

As shown in FIG. 5, after acquisition of these mass spectra, the extracted ion chromatogram of each peptide can be determined as a function of MS¹ scan number. This represents the onset of the ion eluting from the IM device. In other words, following the acquisition of the full MS¹ scan range described in FIG. 4, the extracted ion chromatograms are plotted as function of MS¹ scan number. Each ion's extracted ion chromatogram shows the onset of when the ion first becomes present. As the MS¹ scan time is defined by the transient length and therefore corresponds to the arrival time, knowing the delays associated with each individual scan, the scan numbers can be correlated to effective arrival time and the arrival time of each peptide determined.

In particular, the extracted ion chromatograms can be processed to convert MS¹ scan number to arrival time according to Equation 1:

$$Calibrated Arrival {Time}_{x} = {MS}^{1} {ScanTime}_{x , max} + \frac{Δ t}{2} , \qquad ( 1 )$$

where x represents each individual MS¹ Scan, MS¹ ScanTime_{x,max} is the maximum time covered by the acquisition, and Δt is the known delay.

Furthermore, a derivative approximation can be used to determine the intensity of a peptide as a function of scan number from the extracted ion chromatogram by applying Equation 2:

$${Intensity}_{x} = \frac{\begin{matrix}Normalized Summed {Intensity}_{x + 1} - \\ Normalized Summed {Intensity}_{x}\end{matrix}}{0.5 \times Δ t} , \qquad ( 2 )$$

where Normalized Summed Intensityₓ and Normalized Summed Intensityₓ₊₁ are the intensities from MS¹ scan x and x+1, respectively. Equation 2 is the simplest example, as more elaborate and higher-accuracy procedures may be used in practical implementations.

After processing the extracted ion chromatograms and obtaining the derivative approximation, the positive values of the derivate are used in the calibrated arrival time distribution. Thus, using the extracted ion chromatograms from FIG. 5 and Equation 1, the MS¹ scan number can be converted to arrival time. Moreover, taking a derivative approximation (Equation 2) to determine the relative intensity, the calibrated arrival time distribution can be calculated.

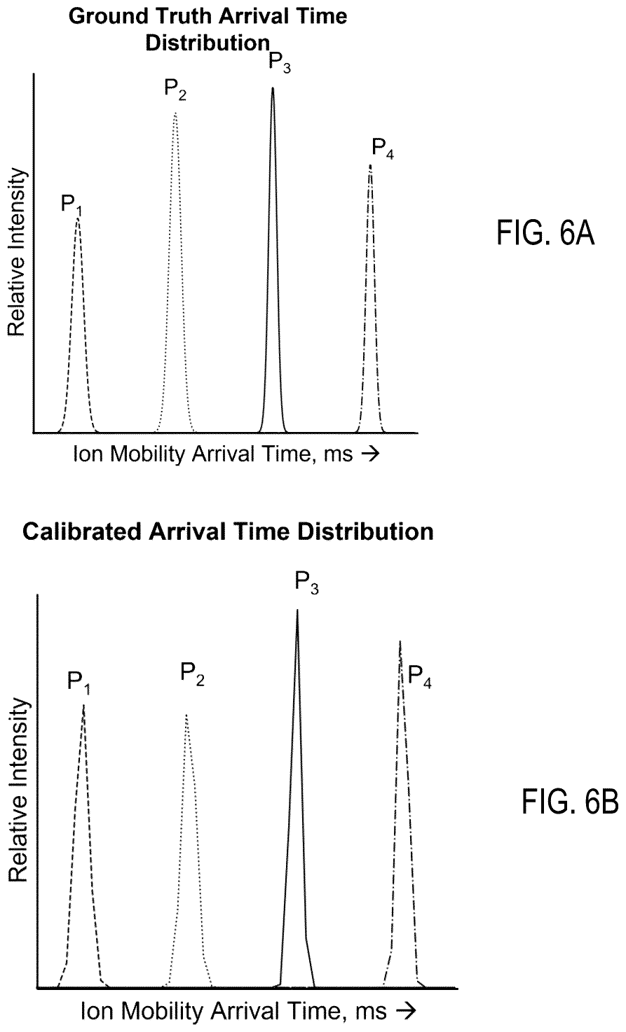

The resulting “calibrated” arrival time versus relative intensity for P1, P2, P3 and P4 are shown in FIG. 6B. FIGS. 6A-6B show a comparison of the “Ground Truth Arrival Time Distribution” and the resulting “Calibrated Arrival Time Distribution” for the P1, P2, P3 and P4 example peptides. Comparing the “Ground Truth Arrival Time Distribution” to the “Calibrated Arrival Time Distribution”, there is good agreement between the apexes of each peptide with respect to the arrival time.

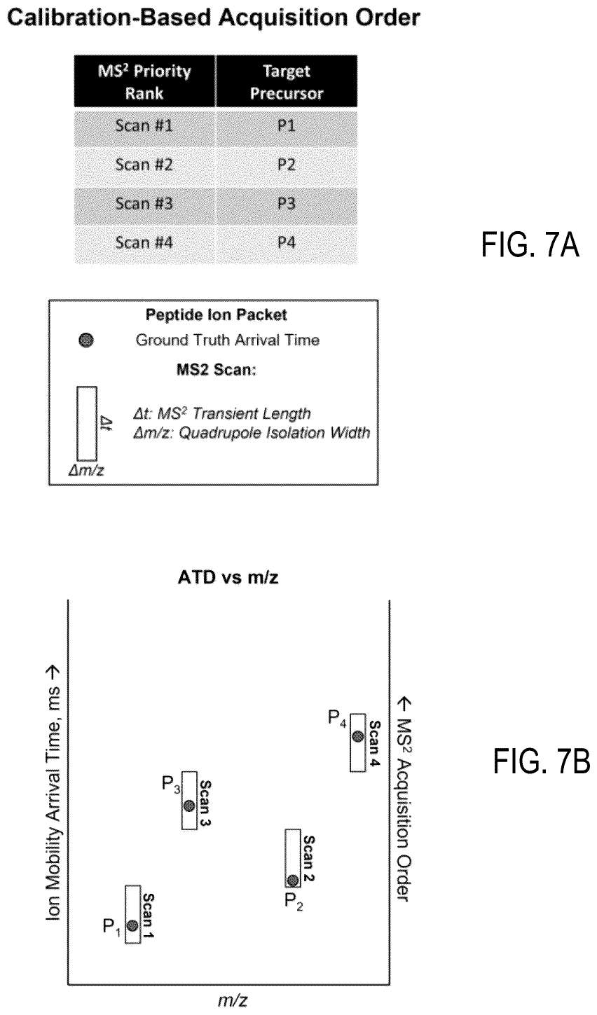

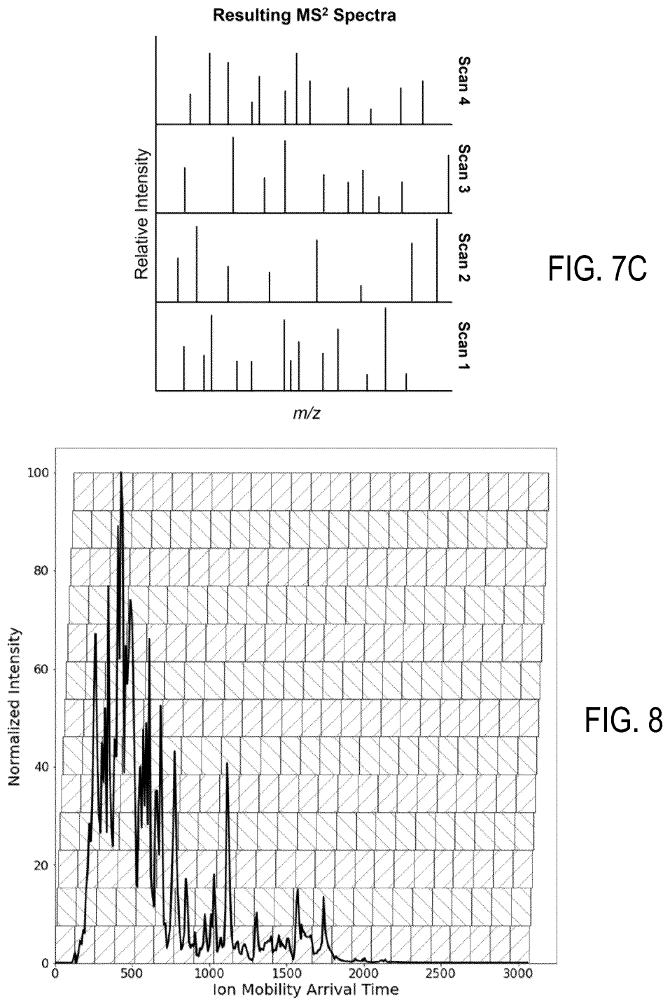

This information, arrival time as a function of m/z and charge state, can then be used to direct the acquisition order of a DDA run, as shown in FIGS. 7A-7C. Applying this to real-world analyses is done by utilizing the similarity of analytes of the same chemical class, e.g., tryptic peptides, groups of proteins, groups of lipids, groups of metabolites, etc., as there is a correlation between arrival time and m/z, as well as charge-state dependencies that form charge-dependent trendlines relating these two variables. Thus, applying the calibration procedure to a known analyte mixture, the charge-state trendlines in IM versus m/z and z space can be determined and used for an unknown analyte separated with the same IM conditions. Analytes of different class are also separated into distinct trendlines, e.g. peptides and lipids are separated into distinct trendlines.

As shown in FIGS. 7A-7C, with the calibrated arrival time distribution of each peptide, the apex of each peptide in ion mobility space is known and can then be used to sort the MS² Priority Rank, earliest arrival time to latest, in a so called “Calibration-based Acquisition Order” (FIG. 7A). Doing so results in an acquisition order of P1, P2, P3, P4 (FIG. 7B) and increases the “successful” targeting of each peptide by MS² analysis as compared to a TopN approach (FIG. 7C).

The calibration procedure was implemented by writing custom instrument control software (ICSW) so that the user can define a desired maximum IM arrival time analysed and the desired delay between MS¹ scans. As IM arrival times can range up to seconds, to maximize throughput, rather than running a single MS¹ scan per IM separation as described above, several MS¹ scans were run per IM separation, termed a “cycle”, and then this cycle was shifted by a user-defined delay on the next injection. The effect of this is seen in FIG. 8, wherein a MS¹ scan is represented by a single hatched rectangle, and where one “cycle” of IM separation is performed per row of rectangles.

In particular, FIG. 8 shows the arrival time distribution (black trace) of a tryptic BSA digest acquired for direct infusion on an IM-MS system. In the background, the MS¹ scans (hatched rectangles) are shown where each row represents an ion injection in the IM system and subsequent IM separation. The MS¹ scans are shifted in time to iterate across the entire desired ion mobility time, in this example 3000 ms. However, in this practical implementation a cycle of MS¹ scans is executed (denoted by a row of hatched rectangles) and then the same cycle is executed again at a time delay Δt (next row).

This process is repeated until the last MS¹ scan of the cycle covers the maximum arrival time desired, analogous to “MS1 Scan n” in FIG. 4, so that the entire arrival time space is mapped. Timing is achieved through the use of contact closures to and from the mass spectrometer to the ion mobility separation device.

It should be noted that a real FTMS instrument has noticeable duration(s) of time when it is not capable of receiving ions, e.g. due to switching of voltages or other overheads. These times can reach in some cases tens of percent of the MS¹ scan time. This means that the rectangles in FIG. 8 have non-zero gaps between them. However, the overall principle of operation remains essentially the same. Also, other tools such as buffering of the IMS output in a dedicated ion trapping device, may be employed.

The calibration procedure was performed on a BSA tryptic digest through direct infusion (black trace, FIG. 8) and the resulting raw file was then analysed using an offline tool. This tool iterates over all MS¹ scans in the raw file and determines ion signals for the 1+, 2+, and 3+ charge states above a certain user-defined ion intensity. Once this list was generated, the extracted ion chromatogram for each signal was determined and the calibration procedure (Equations 1 and 2) was applied. The apex of reconstructed arrival time distribution for each ion signal was then determined and plotted as function of m/z and charge state. A linear regression was then performed on each ion charge state separately to determine the equation for the various trendlines. Charge state was determined from high-resolution accurate mass spectra acquired by FTMS.

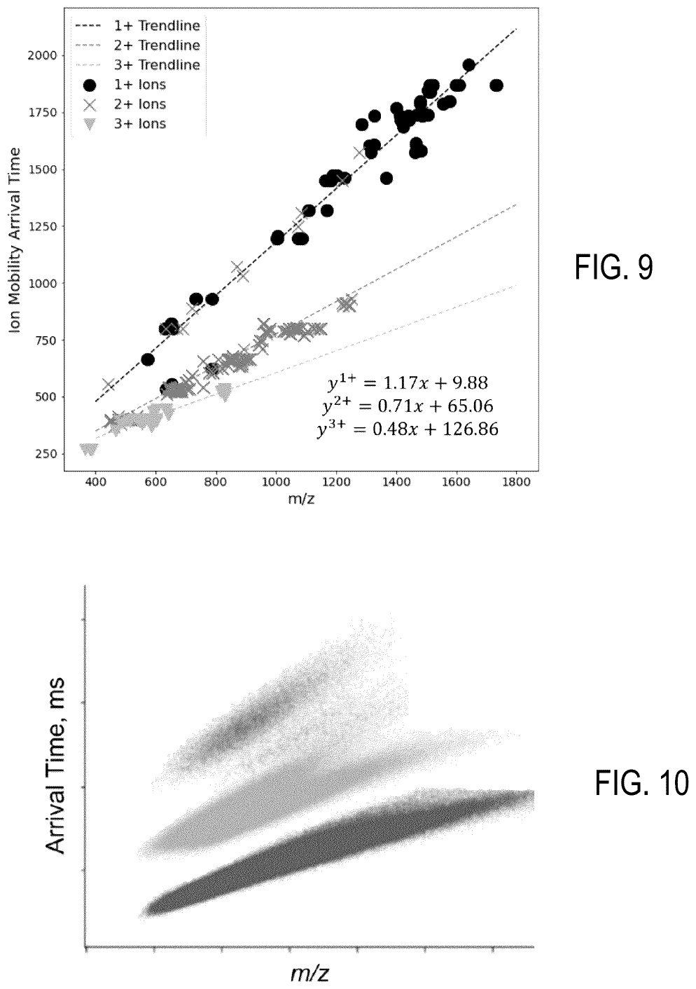

The resulting 2-dimensional plot is shown in FIG. 9. In FIG. 9, the calibration procedure has been applied to the acquisition described in FIG. 8 and the arrival time apexes for each ion signal measure in m/z is plotted. Consistent with literature, ion charge states largely cluster together into linear trendlines. There are exceptions to this where 1+ or 2+ ions fall on different charge state trendlines. However, this is likely due to errors in charge state assignment in the raw file and even with these misassigned charge state ions included, due to the majority of the ions being correctly assigned, the calculated trendline shows good agreement with the calculated apexes.

FIG. 9 shows that the calibration acquisition procedure and subsequent data processing is able to produce trendline data for the three various charge state distributions. The resulting equations (as shown in the lower right inset of FIG. 9) can then be saved for use when DDA is applied to an unknown analyte under the same IM separation conditions. In other words, the charge-state-dependent trendlines can be determined and used to calculated the “Calibration-Based Acquisition Order” for future LC-IM-MS DDA workflows at the same IM settings.

When applied to an unknown analyte, a calibrated arrival time can be calculated for each precursor present in a survey MS¹ scan by knowing its m/z, charge state z and applying the appropriate trendline equation. After these calibrated arrival times are calculated, the MS² Priority Rank can be determined by sorting these calibrated arrival times from earliest to latest, analogous to the example presented in FIGS. 7A-7C.

When analysing real-life analytes, their spread of arrival times for a given m/z might exceed the duration of the scan, as shown in FIG. 10. FIG. 10 shows a compilation of empirically determined arrival times as determined by traditional ion mobility analysis, where the shading is reflective of an ion's charge state. In this case, there is a high chance that an ion of interest will fall outside of the window predicted from the calibration. In this case, real-time processing of acquired spectra should detect such a miss and schedule the next macro-scan in such a way that the same mass window corresponds to the subsequent (or preceding) arrival time window.

It will be understood that in the above-described methods, the ion mobility arrival time versus m/z space of interest for calibrant ions is mapped by performing a plurality of mass analysis scans with start times separated by a delay time Δt. In alternative embodiments, the ion mobility arrival time versus m/z space of interest can instead be mapped by sweeping a quadrupole mass filter across an m/z range during each of a sequence of ion mobility separation scans, where the m/z range over which the mass filter is swept is different in respect of each the ion mobility separation scans.

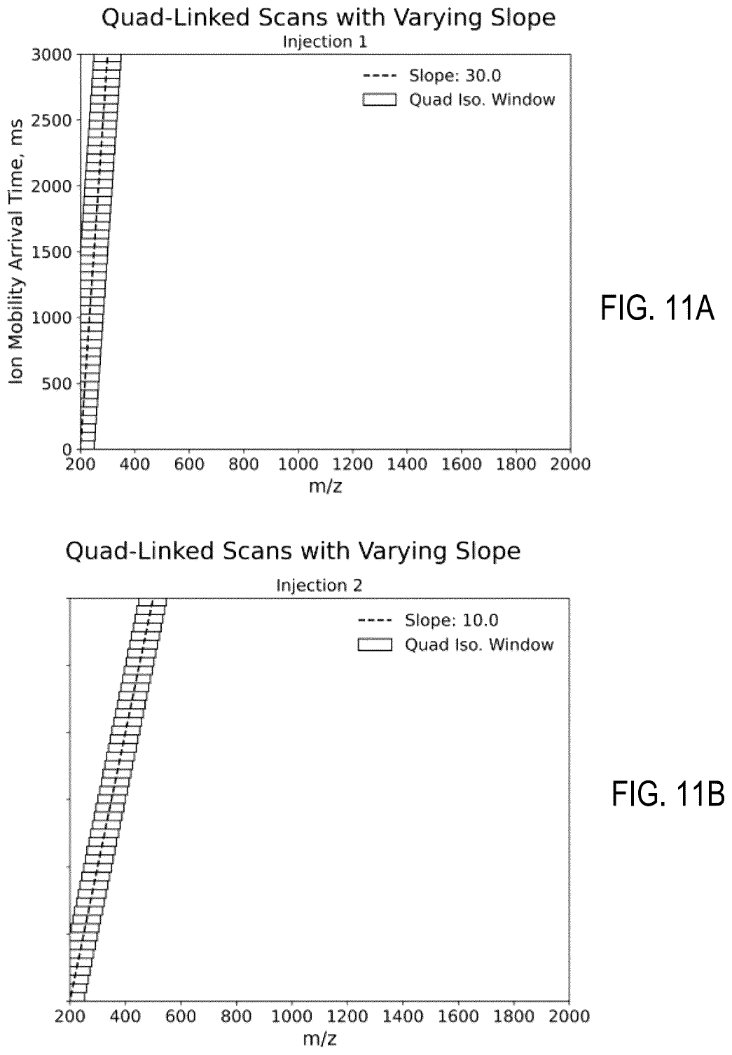

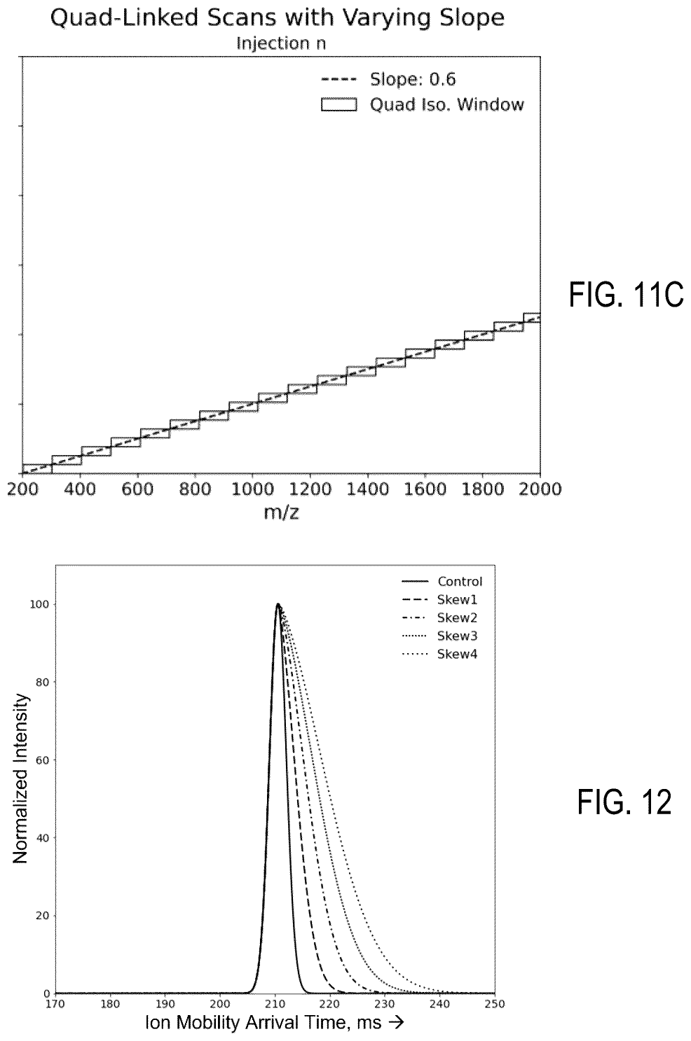

This is illustrated by FIGS. 11A-11C. FIGS. 11A-11C illustrate the mass filter being swept across three different m/z ranges during an ion mobility separation scan, where the rectangles illustrate the quadrupole's isolation window. In FIG. 11A, the quadrupole is swept from about 200 m/z to about 300 m/z during an ion mobility separation scan; in FIG. 11B, the quadrupole is swept from about 200 m/z to about 500 m/z during an ion mobility separation scan; and in FIG. 11C, the quadrupole is swept from about 200 m/z to about 2000 m/z during an ion mobility separation scan.

By appropriate selection of the m/z ranges (i.e. by appropriate selection of their minimum m/z and/or maximum m/z), the combined data from the sequence of ion mobility separation scans may be configured to sample the ion mobility arrival time versus m/z space of interest. As such, the data obtained in this way can again be used to determine the relationship between ion mobility arrival time and m/z for calibrant ions of various different charge states (e.g. singly charged, doubly charged, triply charged, etc.), e.g. in a corresponding manner to that described above.

Although FIGS. 11A-11C illustrate only the slope of a linear m/z sweeps being changed between different ion mobility separation scans, it would also be possible to change the intercept and/or to use non-linear m/z sweeps.

### Assessing Ion Mobility Analyser Performance

In addition to the above-mentioned issue regarding targeting during DDA analyses, the time mismatch between the transient length and the ion mobility arrival time distribution also presents a challenge in determination of the performance of the ion mobility analyser. Under ideal conditions, a population of ions that share collision cross section and m/z values will elute from the ion mobility analyser with a Gaussian time-distribution. However, several technical and ion-chemistry issues can arise that will give rise to an asymmetric peak shape, i.e. peak tailing.

FIG. 12 shows a depiction of five representative ion mobility arrival time distributions. A true Gaussian, labelled “Control”, shows a uniform peak shape around the peak apex. Tailing was simulated in four additional distributions with increasing degrees of tailing, and represents an ion mobility arrival time distribution that is obtained on a poorly performing ion mobility analyser. Each example arrival time distribution was normalized to 100% intensity independently.

This tailing can be detrimental to the overall performance of the ion mobility separation, and inherently the performance of any combined proteomic analysis, as it limits overall sensitivity of the measurement as the ion signal is diluted in arrival time space. Thus, identification of such issues prior to analysis is important to a successful experiment and to the utilisation of sample and instrument time.

Building on the utilization of the calibration method described above, the calibrated arrival time distribution can also be used to assess the “Ground Truth” peak shape and to identify IM analyser performance conditions prior to analysing a sample.

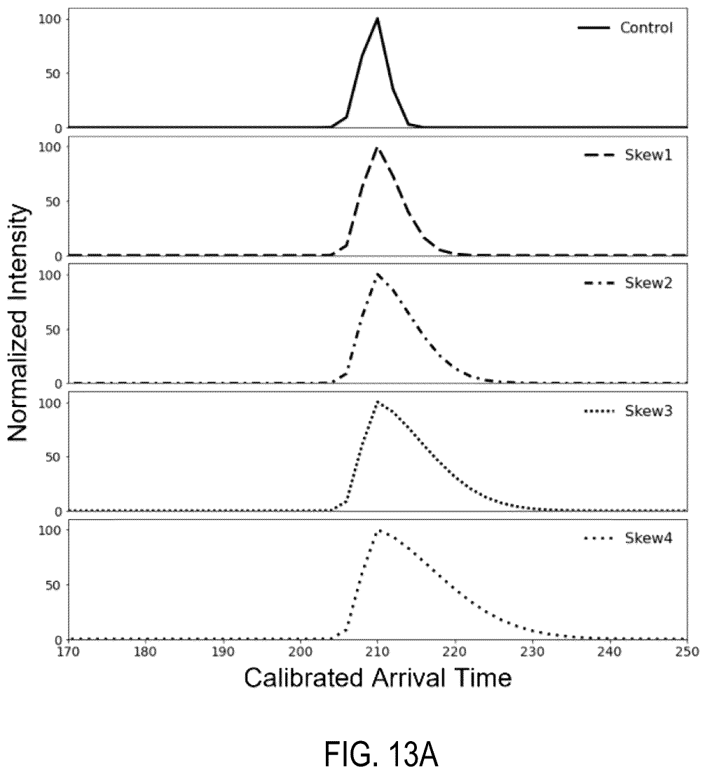

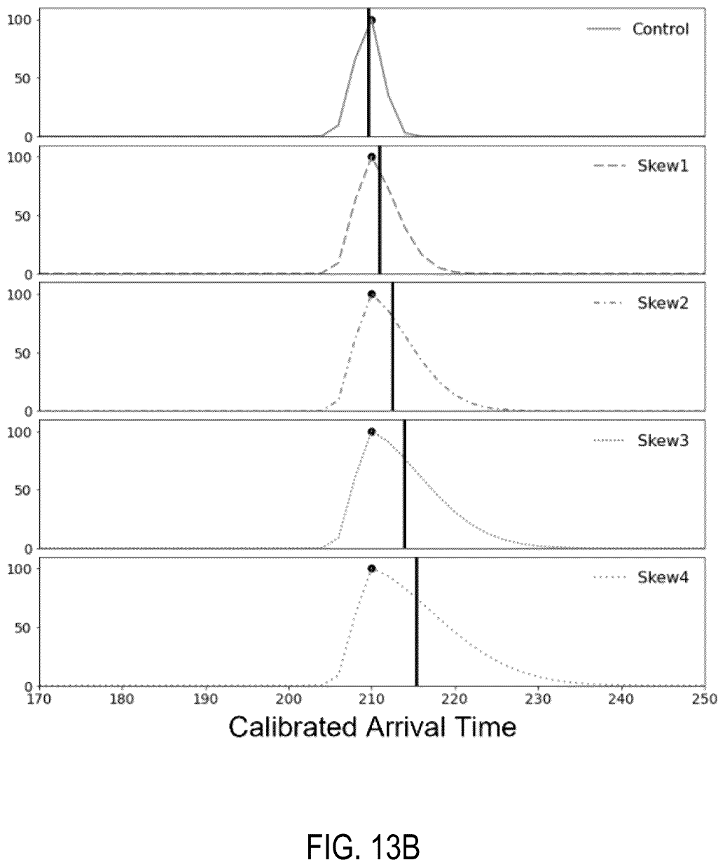

As shown in FIG. 12, the five examples of arrival time distributions show an increasing level of tailing. The calibrated arrival time distributions of the example data shown in FIG. 12 are shown in FIG. 13A. In FIG. 13B, the apex of each distribution is noted with a point and the weighted average is noted with a solid vertical line.

When the calibration method is applied to the example data of FIG. 12, the resulting calibrated arrival time distributions are shown in FIG. 13A. These distributions show good agreement in terms of arrival time apex, which is used for directing DDA workflows. However, they also capture the tailing present in the “ground truth” distributions. Owing to this, these peak shapes can be assessed during the calibration procedure to determine if tailing is present.

As is shown in FIG. 13B, the apex and weighted average of each distribution is calculated. By monitoring the difference between these two values, the amount of asymmetry in peak shape can be determined and in turn the ion mobility analyser performance can be assessed.

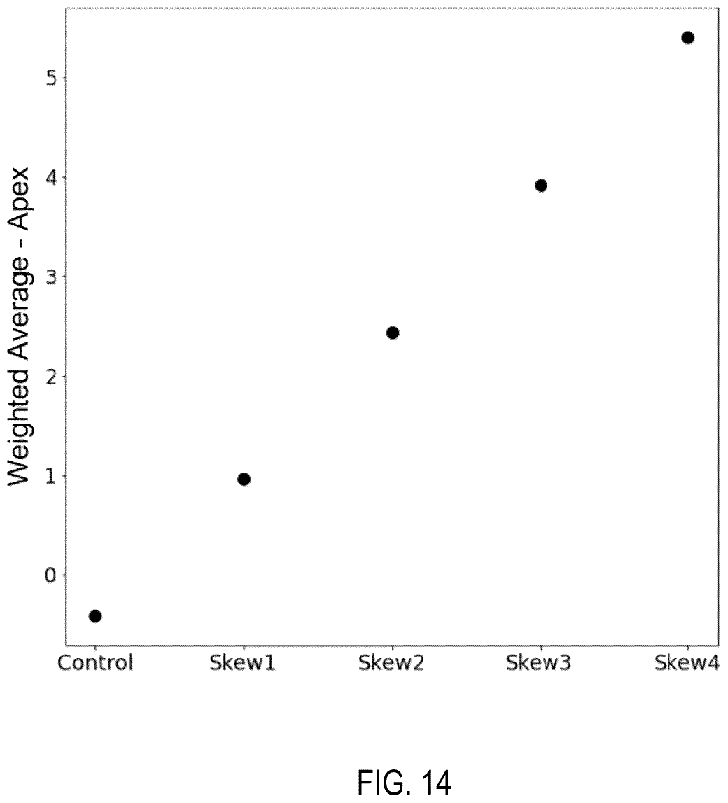

FIG. 14 shows the difference between the weighted average and apex of each calibrated arrival time distribution (see FIG. 13B). For the control dataset, where the peak is a true Gaussian, the difference between these two values is small and arises purely due to time delay steps of the calibration method. For the tailing dataset, where the amount of tailing increase linearly between “Skew1” through “Skew 4”, the difference between weighted average and apex reflects this asymmetry.

With known calibrants, a threshold for the deviation between weighted average and peak apex can be determined and any values outside of this range can highlight the need for instrument re-tuning or even repair.

It will be appreciated that embodiments utilise a new calibration procedure to characterise the charge-dependent relationship between arrival time and m/z for a known mixture, in order to determine a better acquisition order of MS² scans when performing DDA analysis on a chemically-similar, unknown analyte under the same IM conditions.

Embodiments resolve the problem of determining IM with a relatively slow FTMS instrument. The very same problem of wide temporal acceptance window of FTMS instruments is used to improve the quality of IM calibration by monitoring multiple IM peaks simultaneously while scanning the acceptance window relative to the starting moment of IM separation. The typically flat-top peaks of FIG. 5 allow for more accurate determination of charge state z and better signal-to-noise ratio of calibrants comparing e.g. to scanning a very narrow temporal window of ion gating.

Embodiments provide a fast-calibration procedure to be run prior to the analysis of an unknown analyte by LC-IM-MS, which increases the knowledge of the estimated arrival time of ions in the unknown analyte and therefore increases the likelihood of successful MS² analysis when an ion is targeted. Compared to just scanning a narrow gating window over arrival times, this procedure offers increased accuracy and speed. Moreover, this approach can be coupled to numerous front-end separation techniques.

The method may be applied to multiple analytes and chemical species as the calibration procedure can determine ion signals from the acquisition data and is not tied to any one particular analyte. Moreover, the charge-dependent relationship between arrival time and m/z is not unique to peptides ions, i.e., metabolites and lipids exhibit the same trendline behaviour albeit with different slopes and intercepts. Therefore, by choosing an appropriate calibrant mixture, this calibration procedure can be applied to analyses of a variety of analytes.

It should be noted that regarding the conversion of the extracted ion chromatograms to a calibrated arrival time distribution, there are other methods of transformation that can be used to deconvolve the arrival time distribution, and embodiments are not limited to a derivative approximation.

The calibration procedure can be applied to any number of IM settings where ion transmission is achieved, and the IM-setting-dependent trendline data can be applied for analyses using different IM separation settings.

Although various embodiments have been described above particularly in terms of ion mobility separation, it would be possible to perform the method using any type of ion separation technology in which ions are separated according to a (“first”) physico-chemical property. For example, the method may be performed using ion mobility separation, differential ion mobility separation, or mass to charge ratio (m/z) separation. Suitable types of ion separator include but are not limited to the following examples:
1. Ion separation devices configured to sort ions by m/z, e.g. as described in U.S. Pat. No. 10,256,088. An RF voltage is applied across each electrode of a first array of evenly spaced, parallel, and coplanar electrodes and its corresponding electrode of a second array of evenly spaced, parallel, and coplanar electrodes. The RF voltage varies in amplitude according to an RF voltage amplitude gradient. The RF voltage produces an array of different quadrupole RF electric fields in a uniform gap between the first array and the second array. A DC voltage is superimposed on each electrode of the first array and its corresponding electrode of the second array. The DC voltage varies according to a DC voltage gradient in order to produce a DC electric field in the uniform gap. When ions are introduced in the uniform gap, the DC electric field causes the ions to drift toward quadrupole RF electric fields with increasing RF voltage amplitudes where the ions are trapped according to their m/z.
2. Ion traps, or ion trap arrays, e.g. as described in U.S. Pat. No. 9,111,741. An ion storing apparatus may be configured to separate ions by mass-to-charge ratio. An ion trap may comprise at least two or more rows of parallel placed electrode arrays, wherein each electrode array includes at least two or more parallel bar-shaped electrodes. By applying different phase of alternating current voltages on different bar electrodes to create alternating electric fields inside the space between two parallel electrodes of different rows of electrode arrays, multiple linear ion trapping fields are formed in the space between the different rows of electrode arrays which are open to adjacent each other without a real barrier.
3. Separation devices that use “Zeno pulsing” techniques, e.g. as described in the articles “A novel ion trap that enables high duty cycle and wide m/z range on an orthogonal injection TOF mass spectrometer”, J. Am. Soc. Mass Spectrom., 2009, 20, pp. 1342-1348, and “A W-Geometry Ortho-TOF MS with High Resolution and Up to 100% Duty Cycle for MS/MS”, J. Am. Soc. Mass Spectrom., 2017, 28, pp. 2143-2150.
4. Stacked well ion traps, e.g. as described in U.S. Pat. No. 7,872,228. A plurality of electrodes may be positioned and driven by RF potentials to form a plurality of adjacent pseudopotential wells. Ions may be manipulated, reacted, analysed, and ejected from the apparatus in a manner similar to conventional ion traps. In addition, selected ions or groups of ions may be passed from one pseudopotential well to another pseudopotential well without ion losses due to physical obstructions.
5. Orthogonal-flow ion trap arrays, e.g. as described in U.S. Pat. No. 10,651,025. The ion separation device may comprise a plurality of electrodes arranged in a two-dimensional grid, a gas supply configured to provide a gas flow along the first direction, and an ion inlet arranged to receive ions. The plurality of electrodes may be configured to create one or more pseudopotential barriers of increasing magnitude along a first direction. A drag force may be applied to the ions by the gas flow is opposed by a pseudopotential gradient of the plurality of electrodes.
6. Annular traps, e.g. as described in US Patent Application No. U.S. Ser. No. 18/090,730. A system for sorting ions has a group of multipole electrodes configured to form an ion trap, and an ion guide adjacent to the group of multipole electrodes. An RF and DC voltage device is used to apply an RF voltage to the group of multipole electrodes thereby creating a pseudo-potential barrier configured to confine one or more ions. The RF and DC voltage device is also used to apply a DC voltage that creates an axial field in opposition to the pseudo-potential barrier at the exit of the trap. The RF voltage or DC voltage is then ramped up or down, depending on the use case to cause at least one ion to be eluted across the pseudo-potential barrier.
7. Ion centrifuge ion separation devices, e.g. as described in European Patent Application No. EP 4,020,524. An ion separation apparatus may comprise: (a) first and second ion carpets, each comprising: a substrate having first and second faces; and a set of electrodes disposed on or beneath the first face, wherein a configuration of a first plurality of the set of electrodes defines at least one group of circle sectors; (b) an ion exit aperture passing through one ion carpet; and (c) one or more power supplies configured to provide radio frequency voltages to a first subset of the electrodes of each ion carpet, to provide electrical potential differences across electrodes of the first subset of electrodes of each ion carpet, and to provide time-varying voltages to the first plurality of electrodes of each ion carpet that migrate through the sectors as a traveling wave, wherein the ion carpets are disposed parallel to one another with a gap therebetween, the first faces facing one another across the gap.
8. Ion mobility separation devices that use a lens array, e.g. as described in U.S. Pat. No. 11,119,070. A mobility separator includes a two-dimensional grid of electrodes spanning a passage between first and second walls. The first and second walls include an inlet aperture and a plurality of exit apertures, respectively. The two-dimensional grid of electrodes is configured to generate an electric field within the passage. The plurality of ion channels arranged adjacent to the plurality of exit apertures. Movement of ions between the inlet aperture and the plurality of exit apertures are governed by the electric field and a gas flow through the passage between to the first and second walls such that the ions are sorted and directed to different channels based on their respective mobility.
9. Trapped Ion Mobility Separation (TIMS) devices. Although the calibration procedure benefits from reproducible dispersion of ions, such as is the case for dispersive ion mobility, the calibration procedure can also be useful for scanning-based separation techniques, such as differential ion mobility separation. For separation techniques that use an array of ion traps, the calibration procedure can be used in the case that ions are separated into the respective traps and released from the ion traps at a specific cadence.

Although the present invention has been described with reference to various embodiments, it will be understood that various changes may be made without departing from the scope of the invention as set out in the accompanying claims.

1. A method of operating an analytical instrument, the analytical instrument comprising:
an ion separator configured to perform ion separation scans, wherein in each ion separation scan the ion separator receives ions and separates them according to a first physico-chemical property, wherein each ion separation scan has a duration T_{IMS}; and
a mass analyser arranged downstream of the ion separator, wherein the mass analyser is configured to perform mass analysis scans, wherein in each mass analysis scan the mass analyser receives ions and mass analyses them, wherein each mass analysis scan has a duration T_{MA};
the method comprising:
(i) ionising a calibrant to produce calibrant ions;
(ii) the ion separator performing a sequence of ion separation scans, wherein in each ion separation scan the ion separator receives calibrant ions and separates them according to the first physico-chemical property, and wherein each ion separation scan has a respective start time to; and
(iii) the mass analyser performing a plurality of mass analysis scans, wherein in each mass analysis scan the mass analyser receives separated calibrant ions and mass analyses them, wherein the mass analyser performs the plurality of mass analysis scans by performing one or more mass analysis scan(s) during each ion separation scan of the sequence, and wherein each mass analysis scan has a respective start time t^{ij}_{MA} defined relative to the start time to of the ion separation scan during which the mass analysis scan is performed;
wherein start times t^{ij}_{MA} of the plurality of mass analysis scans include start times separated by a delay time Δt, wherein Δt<min(T_{MA}, T_{IMS});
the method further comprising:
(iv) using data obtained from the plurality of mass analysis scans to determine a calibration for the analytical instrument; and/or
(v) using data obtained from the plurality of mass analysis scans to assess an operational state of the ion separator.

2. The method of claim 1, wherein at least an initial mass analysis scan is performed during each ion separation scan of the sequence, with each initial mass analysis scan having a start time t^{i,1}_{MA}, wherein start times t^{i,1}_{MA} of the initial mass analysis scans include start times separated from one another by the delay time Δt.

3. The method of claim 2, wherein at least a second mass analysis scan is performed during each ion separation scan of the sequence, with each second mass analysis scan having a start time t^{i,2}_{MA}, wherein start times t^{i,2}_{MA} of the second mass analysis scans include start times separated from one another by the delay time Δt.

4. The method of claim 2, wherein:
start times t^{i,1}_{MA} of the initial mass analysis scans differ in subsequent ion separation scans from one another by the delay time Δt; and/or
start times t^{i,2}_{MA} of a second mass analysis scans differ in subsequent ion separation scans from one another by the delay time Δt; and/or
the method comprises, in each successive ion separation scan of the sequence, increasing or decreasing the start time t^{i,1}_{MA} of the initial mass analysis scan performed during that ion separation scan by the delay time Δt.

5. The method of claim 1, wherein the delay time Δt is constant.

6. The method of claim 1, wherein (iv) using the data obtained from the plurality of mass analysis scans to determine a calibration for the analytical instrument comprises:
identifying plural different calibrant ions in the data, wherein each different calibrant ion has an associated mass to charge ratio;
determining a charge state and/or chemical class for each identified calibrant ion;
constructing an ion chromatogram for each identified calibrant ion, and determining an ion arrival time for each identified calibrant ion from the ion chromatogram; and
using the mass to charge ratios, charge states and/or chemical classes, and ion arrival times for the plural different calibrant ions to determine the calibration.

7. The method of claim 1, wherein (v) using data obtained from the plurality of mass analysis scans to assess the operational state of the ion separator comprises:
identifying a calibrant ion in the data;
constructing an ion chromatogram for an identified calibrant ion, and using the ion chromatogram to determine an ion arrival time distribution the identified calibrant ion;
determining a first arrival time associated with an apex of the ion arrival time distribution;
determining a second arrival time associated with a weighted average of the ion arrival time distribution; and
when the first and second arrival times differ by more than a threshold amount, determining that the ion separator is in an abnormal operational state.

8. A method of determining a calibration for an analytical instrument, the analytical instrument comprising:
an ion separator configured to perform ion separation scans, wherein in each ion separation scan the ion separator receives ions and separates them according to a first physico-chemical property;
a mass filter arranged downstream of the ion separator, wherein the mass filter is operable in a filtering mode of operation, wherein in the filtering mode of operation the mass filter receives ions and transmits only those ions having mass to charge ratios within a m/z transmission window; and
a mass analyser arranged downstream of the mass filter, wherein the mass analyser is configured to perform mass analysis scans, wherein in each mass analysis scan the mass analyser receives ions and mass analyses them;
the method comprising:
(i) ionising a calibrant to produce calibrant ions;
(ii) the ion separator performing a sequence of ion separation scans, wherein in each ion separation scan, the ion separator receives calibrant ions and separates them according to the first physico-chemical property;
(iii) operating the mass filter in its filtering mode of operation so as to filter separated calibrant ions, and during each ion separation scan of the sequence: scanning a centre mass to charge ratio of the m/z transmission window across a respective mass to charge ratio range Δm/zⁱ, wherein the centre mass to charge ratio of the m/z transmission window is scanned across a respective different mass to charge ratio range Δm/zⁱ for each ion separation scan of the sequence;
(iv) the mass analyser performing a plurality of mass analysis scans by performing one or more mass analysis scan(s) during each ion separation scan of the sequence, wherein in each mass analysis scan the mass analyser receives filtered calibrant ions and mass analyses them; and
(v) using data obtained from the plurality of mass analysis scans to determine a calibration for the analytical instrument.

9. The method of claim 1, further comprising:
(i) ionising a sample to produce sample ions;
(ii) mass analysing sample ions in an MS¹ mode of operation, so as to produce an MS¹ mass spectrum of the sample ions;
(iii) identifying a plurality of precursors of interest in the MS¹ mass spectrum;
(iv) determining an acquisition order for acquiring MS² spectra of the plurality of precursors of interest, wherein the acquisition order is determined using an expected ion arrival time for each precursor of interest, and wherein the expected ion arrival time for each precursor of interest is determined using the calibration; and
(iv) acquiring MS² spectra for the plurality of precursors of interest by:
sequentially selecting, in the acquisition order, each precursor of the plurality of precursors of interest; and
for each selected precursor: fragmenting precursor ions so as to produce fragment ions, and mass analysing the fragment ions so as to produce an MS² spectrum for that precursor.

10. A method of operating an analytical instrument, the analytical instrument comprising:
an ion separator configured to perform ion separation scans, wherein in each ion separation scan the ion separator receives ions and separates them according to a first physico-chemical property; and
a mass analyser arranged downstream of the ion separator, wherein the mass analyser is configured to perform mass analysis scans, wherein in each mass analysis scan the mass analyser receives ions and mass analyses them;
the method comprising:
(i) ionising a sample to produce sample ions;
(ii) mass analysing sample ions in an MS¹ mode of operation, so as to produce an MS¹ mass spectrum of the sample ions;
(iii) identifying a plurality of precursors of interest in the MS¹ mass spectrum;
(iv) determining an acquisition order for acquiring MS² spectra of the plurality of precursors of interest, wherein the acquisition order is determined using an expected ion arrival time for each precursor of interest, and wherein the expected ion arrival time for each precursor of interest is determined using a calibration for the analytical instrument; and
(iv) acquiring MS² spectra for the plurality of precursors of interest by:
sequentially selecting, in the acquisition order, each precursor of the plurality of precursors of interest; and
for each selected precursor: fragmenting precursor ions so as to produce fragment ions, and mass analysing the fragment ions so as to produce an MS² spectrum for that precursor.

11. The method of claim 10, wherein the expected ion arrival time for each precursor of interest is determined by using an m/z and a charge state and/or chemical class of that precursor to determine an expected arrival time from the calibration.

12. The method of claim 10, wherein acquiring MS² spectra for the plurality of precursors of interest comprises:
the ion separator performing multiple ion separation scans, wherein each ion separation scan has a duration T_{IMS}, and wherein each ion separation scan duration T_{IMS} is divided into a plurality of time-periods each corresponding to an MS² mass analysis scan;
wherein the acquisition order is configured such that each precursor is selected during one of the time-periods.

13. The method of claim 1, wherein the calibration comprises an ion arrival time versus mass to charge ratio (m/z) and charge state (z) and/or chemical class calibration.

14. The method of claim 1, wherein the calibration comprises one or more trend lines, with each trend line corresponding to a particular charge state and/or chemical class, and each trend line providing a relationship between ion arrival time and m/z for ions having that charge state and/or of that chemical class.

15. The method of claim 1, wherein the mass analyser is an electrostatic ion trap mass analyser.

16. The method of claim 1, wherein:
the ion separator is an ion mobility separator, and the first physico-chemical property is ion mobility;
the ion separator is a differential ion mobility separator, and the first physico-chemical property is differential ion mobility; or
the ion separator is a device configured to separate ions according to their mass to charge ratio (m/z), and the first physico-chemical property is their mass to charge ratio (m/z).

17. A non-transitory computer readable storage medium storing computer software code which when executed on a processor performs the method of claim 1.

18. A control system for an analytical instrument, the control system configured to cause the analytical instrument to perform the method of claim 1.

19. An analytical instrument, comprising the control system of claim 18.
